(19) United States
(12) Patent Application Publication
(10) Pub. No.: US 2025/0316213 A1
(43) Pub. Date: Oct. 9, 2025

(54) DISPLAY DEVICE AND METHOD OF DRIVING THE SAME, AND ELECTRONIC DEVICE FOR PROVIDING IMAGE

(71) Applicant: Samsung Display Co., LTD., Yongin-si (KR)

(72) Inventors: Sung Hwan KIM, Yongin-si (KR); Min Chul SHIN, Yongin-si (KR); Ji Youn SEO, Yongin-si (KR); Myeong Eon LEE, Yongin-si (KR)

(21) Appl. No.: 18/952,875

(22) Filed: Nov. 19, 2024

(30) Foreign Application Priority Data
Apr. 9, 2024 (KR) 10-2024-0048262

(51) Int. Cl. G09G 3/32; G09G 3/3266; G09G 3/3291

(52) U.S. Cl. CPC G09G 3/32; G09G 3/3266; G09G 3/3291; G09G 2310/0267; G09G 2310/0275; G09G 2320/0233; G09G 2330/021

(57) ABSTRACT

A device includes a first subpixel connected to a first data line and a first emission control line, and including a first light emitting element, a second subpixel connected to a second data line and a second emission control line and including a second light emitting element, a third subpixel connected to a third data line and a third emission control line and including a third light emitting element, a data driver configured to output data voltages of the first subpixel, the second subpixel, and the third subpixel to the first data line, the second data line, and the third data line, respectively, and a scan driver configured to output a first emission control signal of a first width, a second emission control signal of a second width, and a third emission control signal of a third width to the first, second, and the third emission control lines, respectively.

### CROSS-REFERENCE TO RELATED APPLICATION

This application claims priority to and the benefit of Korean Patent Application No. 10-2024-0048262, filed on Apr. 9, 2024, in the Korean Intellectual Property Office, the entire disclosure of which is incorporated by reference herein.

### BACKGROUND

### 1. Field

The present disclosure relates to a display device and a method of driving the same, and an electronic device for providing an image.

### 2. Description of the Related Art

As the information society develops, demands for display devices for displaying images are increasing in various forms. Accordingly, various types of display devices including light emitting display devices are being developed. A light emitting display device includes pixels including respective light emitting elements.

### SUMMARY

Aspects and features of embodiments of the present disclosure provide a display device which can improve consumption efficiency of light emitting elements and a method of driving the display device, and an electronic device for providing an image.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to one or more embodiments of the present disclosure, there is provided a display device including, a first subpixel connected to a first data line and a first emission control line, and including a first light emitting element, a second subpixel connected to a second data line and a second emission control line and including a second light emitting element, a third subpixel connected to a third data line and a third emission control line and including a third light emitting element, a data driver configured to output data voltages of the first subpixel, the second subpixel, and the third subpixel to the first data line, the second data line, and the third data line, respectively, and a scan driver configured to output a first emission control signal of a first width, a second emission control signal of a second width, and a third emission control signal of a third width to the first emission control line, the second emission control line, and the third emission control line, respectively. The first subpixel, the second subpixel, and the third subpixel may be configured to emit light during different times in response to the first emission control signal, the second emission control signal, and the third emission control signal, respectively.

In one or more embodiments, the data driver may be configured to output the data voltages of different magnitudes to the first data line, the second data line, and the third data line, in response to each grey scale of video data.

In one or more embodiments, the first subpixel, the second subpixel, and the third subpixel may include respective pixel circuits configured to generate a first driving current, a second driving current, and a third driving current, respectively, in response to the data voltages.

In one or more embodiments, the pixel circuit of the first subpixel may be configured to supply the first driving current to the first light emitting element during a first emission period corresponding to the first width, the pixel circuit of the second subpixel may be configured to supply the second driving current to the second light emitting element during a second emission period corresponding to the second width, and the pixel circuit of the third subpixel may be configured to supply the third driving current to the third light emitting element during a third emission period corresponding to the third width.

In one or more embodiments, the first driving current may be greater than the second driving current and the third driving current, and the first emission period may be shorter than the second emission period and the third emission period.

In one or more embodiments, the second driving current may be smaller than the first driving current and the third driving current, and the second emission period may be longer than the first emission period and the third emission period.

In one or more embodiments, the first light emitting element, the second light emitting element, and the third light emitting element may be configured to emit light of different colors and may have different current efficiency.

In one or more embodiments, the first light emitting element may be configured to emit first light of red color, the second light emitting element maybe configured to emit second light of green color, and the third light emitting element may be configured to emit third light of blue color.

In one or more embodiments, the first driving current may be greater than the second driving current and the third driving current, and the second driving current may be smaller than the first driving current and the third driving current.

In one or more embodiments, the first emission period may be shorter than the second emission period and the third emission period, and the second emission period may be longer than the first emission period and the third emission period.

In one or more embodiments, the first light emitting element may be configured to exhibit maximum efficiency at a current range of 100 μA to 300 μA, and the first driving current corresponding to a maximum gray level of the video data may be in a range of 100 μA to 300 μA.

In one or more embodiments, the second light emitting element may be configured to exhibit maximum efficiency at a current range of 10 μA to 20 μA, and the second driving current corresponding to a maximum gray level of the video data may be in a range of 10 μA to 20 μA.

In one or more embodiments, the third light emitting element may exhibit maximum efficiency at a current range of 20 μA to 40 μA, and the third driving current corresponding to a maximum gray level of the video data may be in a range of 20 μA to 40 μA.

In one or more embodiments, the first driving current may be N times the second driving current, and the first emission period may be 1/N times the second emission period.

In one or more embodiments, the display device may further include a pixel including the first subpixel, the second subpixel, and the third subpixel, and the first subpixel, the second subpixel, and the third subpixel may be on a same horizontal line in a display area in which the pixel is located.

In one or more embodiments, the display device may further include at least one scan line connected to the first subpixel, the second subpixel, and the third subpixel.

In one or more embodiments, the scan driver may include, at least one scan signal output unit configured to output at least one scan signal to at least the one scan line, and an emission control signal output unit configured to output the first emission control signal, the second emission control signal, and the third emission control signal to the first emission control line, the second emission control line, and the third emission control line, respectively.

According to one or more embodiments of the present disclosure, there is provided a method of driving a display device, the method including, driving a first subpixel, a second subpixel, and a third subpixel with driving currents of different magnitudes in response to each grey scale of video data, and controlling emission periods of the first subpixel, the second subpixel, and the third subpixel to be different depending on the driving currents of the first subpixel, the second subpixel, and the third subpixel, respectively.

In one or more embodiments, the driving the first subpixel, the second subpixel, and the third subpixel with the driving currents of different magnitudes may include, setting the driving currents of the first subpixel, the second subpixel, and the third subpixel as a first driving current, a second driving current, and a third driving current in accordance with efficiency of each of light emitting elements in the first subpixel, the second subpixel, and the third subpixel, and supplying data voltages of magnitudes corresponding to the first driving current, the second driving current, and the third driving current to the first subpixel, the second subpixel, and the third subpixel, respectively.

In one or more embodiments, the controlling the emission periods of the first subpixel, the second subpixel, and the third subpixel to be different may include, setting the emission periods of the first subpixel, the second subpixel, and the third subpixel to be different so that the emission periods decreases as magnitude of the driving current corresponding to each grey scale of video data increases, and supplying the emission control signals corresponding to each of the emission periods of the first subpixel, the second subpixel, and the third subpixel to the first subpixel, the second subpixel, and the third subpixel.

According to one or more embodiments of the present disclosure, there is provided an electronic device for providing an image, including a display device, the display device including, a first subpixel connected to a first data line and a first emission control line, and including a first light emitting element, a second subpixel connected to a second data line and a second emission control line and including a second light emitting element, a third subpixel connected to a third data line and a third emission control line and including a third light emitting element, a data driver configured to output data voltages of the first subpixel, the second subpixel, and the third subpixel to the first data line, the second data line, and the third data line, respectively, and a scan driver configured to output a first emission control signal of a first width, a second emission control signal of a second width, and a third emission control signal of a third width to the first emission control line, the second emission control line, and the third emission control line, respectively. The first subpixel, the second subpixel, and the third subpixel may be configured to emit light during different times in response to the first emission control signal, the second emission control signal, and the third emission control signal, respectively.

According to a display device and a method of driving the same according to embodiments, the light emission luminance of the subpixels can be uniformly maintained at the same time as improving the consumption efficiency (or power efficiency) of the light emitting elements disposed in each subpixel. Accordingly, power consumption of the display device can be improved, and display quality can be secured.

However, effects according to the embodiments of the present disclosure are not limited to those exemplified above and various other effects are incorporated herein.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of a display device according to one or more embodiments;

FIG. 2 is a layout view of the display device according to one or more embodiments;

FIG. 3 is a block diagram of the display device according to one or more embodiments;

FIG. 4 is an equivalent circuit diagram of a subpixel according to one or more embodiments;

FIG. 5 is a layout view illustrating pixels of a display area according to one or more embodiments;

FIG. 6 is a cross-sectional view illustrating an example of a cross section of a display panel corresponding to the line I1-I1′ of FIG. 5;

FIG. 7 is a detailed cross-sectional view of an example of an area A of FIG. 6;

FIG. 8 is a cross-sectional view illustrating an example of a cross section of a display panel corresponding to the line I1-I1′ of FIG. 5;

FIG. 9 is a cross-sectional view illustrating an example of a cross section of a display panel corresponding to the line I1-I1′ of FIG. 5;

FIG. 10 is a graph illustrating a driving current of a subpixel for each gray level according to one or more embodiments;

FIG. 11 is a graph showing efficiency of a first light emitting element according to a driving current;

FIG. 12 is a graph showing efficiency of a second light emitting element according to a driving current;

FIG. 13 is a graph showing efficiency of a third light emitting element according to a driving current;

FIG. 14 is a block diagram of a display device according to one or more embodiments;

FIG. 15 is a graph showing a driving current and an emission period of a first light emitting element according to one or more embodiments;

FIG. 16 is a graph showing a driving current and an emission period of a second light emitting element according to one or more embodiments;

FIG. 17 is a graph showing a driving current and an emission period of a third light emitting element according to one or more embodiments;

FIG. 18 is a waveform diagram of emission control signals according to one or more embodiments;

FIG. 19 is an example view of a smart watch including a display device according to one or more embodiments;

FIGS. 20 and 21 are example views of a virtual reality (VR) device including a display device according to one or more embodiments;

FIG. 22 is an example view of a VR device including a display device according to one or more embodiments;

FIG. 23 is an example view illustrating a vehicle instrument cluster and center fascia including display devices according to one or more embodiments; and

FIG. 24 is an example view of a transparent display device including a display device according to one or more embodiments.

### DETAILED DESCRIPTION

The present disclosure will now be described more fully hereinafter with reference to the accompanying drawings, in which embodiments of the present disclosure are shown. The present disclosure may, however, be embodied in different forms and should not be construed as limited to the embodiments set forth herein. Rather, these embodiments are provided so that the present disclosure will be thorough and complete, and will fully convey the scope of the present disclosure to those skilled in the art.

It will also be understood that when an element or a layer is referred to as being “on” another element or layer, it can be directly on the other element or layer, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Features of each of various embodiments of the present disclosure may be partially or entirely combined with each other and may technically variously interwork with each other, and respective embodiments may be implemented independently of each other or may be implemented together in association with each other.

The terms “about” or “approximately” as used herein is inclusive of the stated value and means within an acceptable range of deviation for the particular value as determined by one of ordinary skill in the art, considering the measurement in question and the error associated with measurement of the particular quantity (for example, the limitations of the measurement system). For example, “about” may mean within one or more standard deviations, or within ±30%, 20%, 10%, 5% of the stated value.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.” In the specification and the claims, the phrase “at least one of” is intended to include the meaning of “at least one selected from the group of” for the purpose of its meaning and interpretation. For example, “at least one of A and B” may be understood to mean “A, B, or A and B.”

Unless otherwise defined or implied, all terms used herein (including technical and scientific terms) have the same meaning as commonly understood by those skilled in the art to which the present disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the specification.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

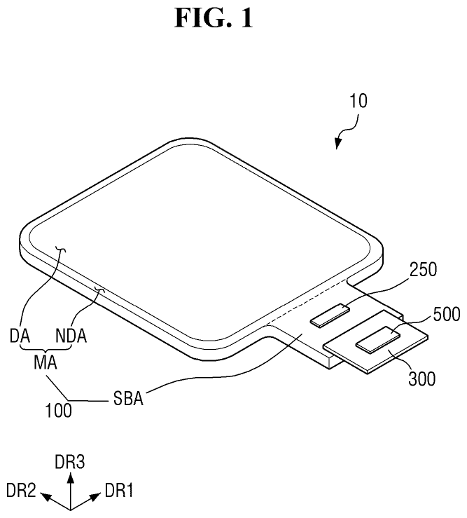

FIG. 1 is a perspective view of a display device according to one or more embodiments.

Referring to FIG. 1, a display device 10 is a device for displaying moving images and/or still images. The display device 10 may be used as a display screen in portable electronic devices such as mobile phones, smartphones, tablet personal computers (PCs), smart watches, watch phones, mobile communication terminals, electronic notebooks, electronic books, portable multimedia players (PMPs), navigation devices and ultra-mobile PCs (UMPCs), as well as in various products such as televisions, notebook computers, monitors, billboards, and/or Internet of things (IoT) devices.

The display device 10 may be a light emitting display device such as an organic light emitting display device using an organic light emitting diode (OLED), a quantum dot light emitting display device including a quantum dot light emitting layer, an inorganic light emitting display device including an inorganic semiconductor, or a micro- or nano-light emitting display device using a micro- or nano-light emitting diode (LED). A case where the display device 10 is a micro- or nano-light emitting display device will be mainly described below, but the present disclosure is not limited thereto. For ease of description, a micro- or nano-LED will be referred to as a light emitting element.

The display device 10 includes a display panel 100, a display driver 250, a circuit board 300, and a power supply unit 500.

The display panel 100 may be shaped like a rectangular plane having short sides in a first direction DR1 and long sides in a second direction DR2 intersecting the first direction DR1. Each corner where a short side extending in the first direction DR1 meets a long side extending in the second direction DR2 may be rounded to have a suitable curvature (e.g., a predetermined curvature) or may be right-angled. The planar shape of the display panel 100 is not limited to a quadrangular shape but may also be other polygonal shapes, a circular shape, and/or an elliptical shape. The display panel 100 may be formed flat, but the present disclosure is not limited thereto. For example, the display panel 100 may include a curved portion formed at left and right ends and having a constant or varying curvature. In addition, the display panel 100 may be formed to be flexible so that it can be curved, bent, folded, and/or rolled.

The display panel 100 may include a main area MA and a sub-area SBA.

The main area MA may include a display area DA which displays an image and a non-display area NDA disposed around the display area DA along an edge or a periphery of the display area DA. The display area DA may include a plurality of pixels which display an image. Each of the pixels may include a plurality of subpixels. For example, each of the pixels may include a first subpixel that emits first light, a second subpixel that emits second light, and a third subpixel that emits third light, but the present disclosure is not limited thereto.

The sub-area SBA may protrude from a side of the main area MA in the second direction DR2. Although the sub-area SBA is unfolded in FIG. 1, it may be bent. In this case, the sub-area SBA may be placed on a lower surface of the display panel 100. When the sub-area SBA is bent, it may be overlapped by the main area MA in a third direction DR3 which is a thickness direction of the display panel 100. The display driver 250 may be disposed in the sub-area SBA.

The display driver 250 may generate signals and voltages for driving the display panel 100. The display driver 250 may be formed as an integrated circuit (IC) and attached onto the display panel 100 using a chip on glass (COG) method, a chip on plastic (COP) method, and/or an ultrasonic bonding method. However, the present disclosure is not limited thereto. For example, the display driver 250 may also be attached onto the circuit board 300 using a chip on film (COF) method.

The circuit board 300 may be attached to an end of the sub-area SBA of the display panel 100. Accordingly, the circuit board 300 may be electrically connected to the display panel 100 and the display driver 250. The display panel 100 and the display driver 250 may receive digital video data, timing signals, and driving voltages through the circuit board 300. The circuit board 300 may be a flexible printed circuit board (FPCB), a printed circuit board (PCB), or a flexible film such as a chip on film (COF).

The power supply unit 500 may generate a plurality of panel driving voltages according to a power supply voltage from the outside. The power supply unit 500 may be formed as an integrated circuit (IC) and attached onto the circuit board 300 using a COF method.

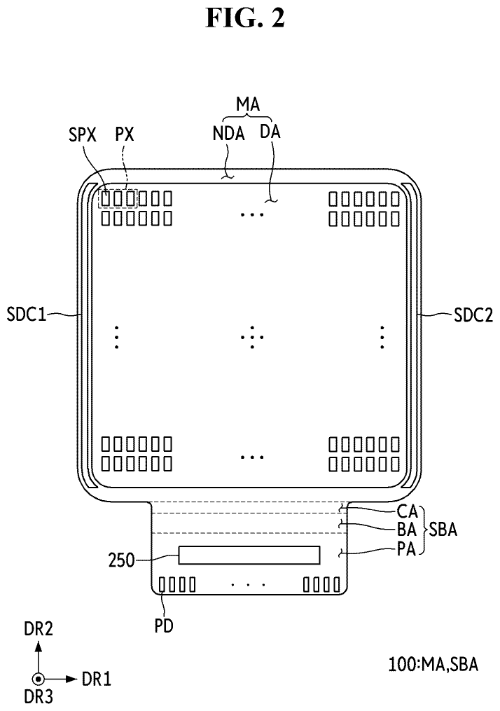

FIG. 2 is a layout view of the display device according to the embodiment. FIG. 2 illustrates a state in which the sub-area SBA is unfolded.

Referring to FIG. 2, the display panel 100 may include the main area MA and the sub-area SBA.

The main area MA may include the display area DA that displays an image and the non-display area NDA disposed around the display area DA. The display area DA may occupy most of the main area MA. The display area DA may be disposed in the center of the main area MA.

The display area DA may include a plurality of pixels PX for displaying an image, and each of the pixels PX may include a plurality of subpixels SPX. A pixel PX may be defined as a smallest subpixel group that can express a white gray level.

The non-display area NDA may neighbor the display area DA. The non-display area NDA may be an area outside the display area DA. The non-display area NDA may be around (e.g., may surround) the display area DA. The non-display area NDA may be an edge area of the display panel 100.

A first scan driver SDC1 and a second scan driver SDC2 may be disposed in the non-display area NDA. The first scan driver SDC1 may be disposed on a side (e.g., a left side) of the display panel 100, and the second scan driver SDC2 may be disposed on the other side (e.g., a right side) of the display panel 100. However, the present disclosure is not limited thereto. Each of the first scan driver SDC1 and the second scan driver SDC2 may be electrically connected to the display driver 250 through scan fan-out lines. Each of the first scan driver SDC1 and the second scan driver SDC2 may receive a scan timing control signal from the display driver 250, generate scan signals according to the scan timing control signal, and output the scan signals to scan lines.

The sub-area SBA may protrude from a side of the main area MA in the second direction DR2. A length of the sub-area SBA in the second direction DR2 may be smaller than a length of the main area MA in the second direction DR2. A length of the sub-area SBA in the first direction DR1 may be smaller than a length of the main area MA in the first direction DR1 or may be substantially equal to the length of the main area MA in the first direction DR1. The sub-area SBA may be bent and placed under the display panel 100. In this case, the sub-area SBA may be overlapped by the main area MA in the third direction DR3.

The sub-area SBA may include a connection area CA, a pad area PA, and a bending area BA.

The connection area CA is an area protruding from a side of the main area MA in the second direction DR2. A side of the connection area CA may contact the non-display area NDA of the main area MA, and the other side of the connection area CA may contact the bending area BA.

The pad area PA is an area where pads PD and the display driver 250 are disposed. The display driver 250 may be attached to driving pads of the pad area PA using a conductive adhesive member such as an anisotropic conductive film. The circuit board 300 may be attached to the pads PD of the pad area PA using a conductive adhesive member such as an anisotropic conductive film. A side of the pad area PA may contact the bending area BA.

The bending area BA is a bendable area. When the bending area BA is bent, the pad area PA may be placed under the connection area CA and the main area MA. The bending area BA may be disposed between the connection area CA and the pad area PA. A side of the bending area BA may contact the connection area CA, and the other side of the bending area BA may contact the pad area PA.

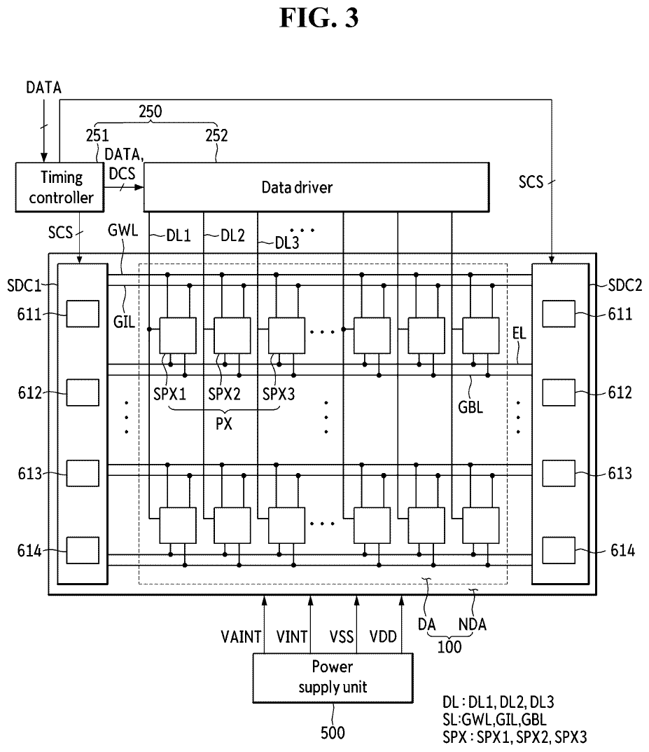

FIG. 3 is a block diagram of the display device according to one or more embodiments.

Referring to FIG. 3, the display area DA includes a plurality of pixels PX, a plurality of scan lines SL, a plurality of emission control lines EL, and a plurality of data lines DL.

The pixels PX may be arranged in a matrix form along the first direction DR1 and the second direction DR2. For example, the pixels PX may be arranged along rows and columns of a matrix along the first direction DR1 and the second direction DR2. The scan lines SL and the emission control lines EL may extend in the first direction DR1 and may be arranged along the second direction DR2. The data lines DL may extend in the second direction DR2 and may be arranged along the first direction DR1. The scan lines SL include a plurality of write scan lines GWL, a plurality of initialization scan lines GIL, and a plurality of bias scan lines GBL.

Each of the pixels PX may include a plurality of subpixels SPX. For example, each of the pixels PX may include a first subpixel SPX1, a second subpixel SPX2, and a third subpixel SPX3.

Each of the subpixels SPX may be connected to at least one scan line SL. For example, each of the subpixels SPX may be connected to one of the write scan lines GWL, one of the initialization scan lines GIL, one of the bias scan lines GBL, one of the emission control lines EL, and one of the data lines DL. Each of the subpixels SPX may receive a data voltage of a data line DL according to a write scan signal of a write scan line GWL and may emit light from a light emitting element according to the data voltage.

The subpixels SPX may be connected to different data lines DL. For example, the first subpixel SPX1, the second subpixel SPX2, and the third subpixel SPX3 constituting one pixel PX may be connected to a first data line DL1, a second data line DL2, and a third data line DL3, respectively. Accordingly, the emission luminance of each of the subpixels SPX can be individually controlled

In one or more embodiments, the subpixels SPX constituting each pixel PX may be connected to the same emission control line EL. Accordingly, the subpixels SPX of each pixel PX may or may not emit light substantially concurrently (e.g., simultaneously).

The non-display area NDA includes the scan drivers SDC1 and SDC2 and the display driver 250. In one or more embodiments, the scan drivers SDC1 and SDC2 may include the first scan driver SDC1 and the second scan driver SDC2.

Each of the first scan driver SDC1 and the second scan driver SDC2 may include one or more scan signal output units 611 through 613 and an emission control signal output unit 614. In one or more embodiments, at least one of the scan signal output units 611 through 613 may include a write scan signal output unit 611, an initialization scan signal output unit 612, and a bias scan signal output unit 613. Each of the write scan signal output unit 611, the initialization scan signal output unit 612, the bias scan signal output unit 613, and the emission control signal output unit 614 may receive a scan timing control signal SCS from a timing controller 251.

The write scan signal output unit 611 may generate write scan signals according to the scan timing control signal SCS of the timing controller 251 and sequentially output the write scan signals to the write scan lines GWL.

The initialization scan signal output unit 612 may generate initialization scan signals according to the scan timing control signal SCS and sequentially output the initialization scan signals to the initialization scan lines GIL.

The bias scan signal output unit 613 may generate bias scan signals according to the scan timing control signal SCS and sequentially output the bias scan signals to the bias scan lines GBL. The emission control signal output unit 614 may generate emission control signals according to the scan timing control signal SCS and sequentially output the emission control signals to the emission control lines EL.

The display driver 250 includes the timing controller 251 and a data driver 252.

The data driver 252 may receive video data DATA (e.g., digital video data) and a data timing control signal DCS from the timing controller 251. The data driver 252 converts the video data DATA into analog data voltages according to the data timing control signal DCS and outputs the analog data voltages to the data lines DL (DL1, DL2, DL3). For example, the data driver 252 may output data voltages of the first subpixel SPX1, the second subpixel SPX2 and the third subpixel SPX3 to the first data line DL1, the second data line DL2, and the third data line DL3, respectively. Subpixels SPX may be selected by write scan signals of the first scan driver SDC1 and the second scan driver SDC2, and the data voltages may be supplied to the selected subpixels SPX.

In one or more embodiments, each of the subpixels SPX may emit light in response to an emission control signal of a gate-on voltage supplied from an emission control line EL after a data voltage is supplied, and the emission luminance of each of the subpixels SPX may correspond to the data voltage. For example, one driving cycle of subpixels SPX and a pixel PX including the subpixels SPX may include a data write period during which the subpixels SPX are selected by a write scan signal and supplied with data voltages, respectively, and an emission period during which driving currents corresponding to the data voltages flow through the subpixels SPX in response to an emission control signal.

The timing controller 251 may receive the video data DATA and timing signals from the outside. The timing controller 251 may generate the scan timing control signal SCS and the data timing control signal DCS for controlling the display panel 100 according to the timing signals. The timing controller 251 may output the scan timing control signal SCS to the first scan driver SDC1 and the second scan driver SDC2. The timing controller 251 may output the video data DATA and the data timing control signal DCS to the data driver 252.

The power supply unit 500 may generate a plurality of panel driving voltages according to a power supply voltage supplied from the outside. For example, the power supply unit 500 may generate a first power supply voltage VDD, a second power supply voltage VSS, a third power supply voltage VINT, and a fourth power supply voltage VAINT and supply them to the display panel 100.

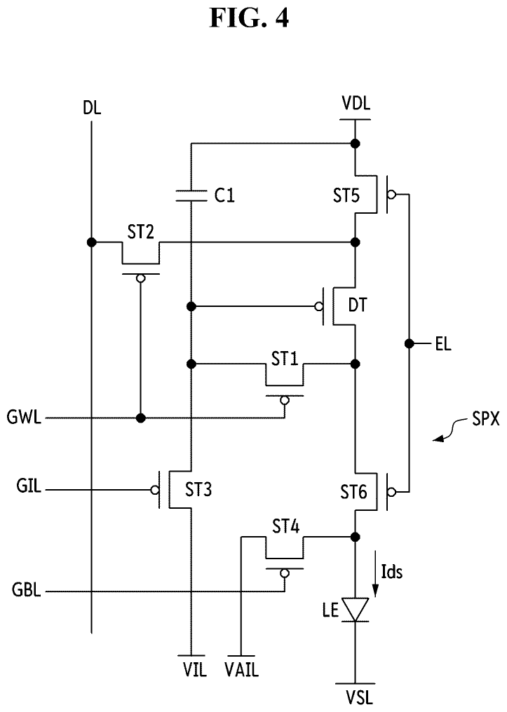

FIG. 4 is an equivalent circuit diagram of a subpixel according to one or more embodiments.

Referring to FIG. 4, the subpixel SPX according to the embodiment may be connected to scan lines GWL, GIL and GBL, an emission control line EL, and a data line DL. For example, the subpixel SPX may be connected to a write scan line GWL, an initialization scan line GIL, a bias scan line GBL, the emission control line EL, and the data line DL.

The subpixel SPX according to the embodiment includes a driving transistor DT, switch elements, a capacitor C1, and a light emitting element LE. The switch elements include first through sixth transistors ST1 through ST6. The driving transistor DT, the switch elements, and the capacitor C1 may form a pixel circuit of the subpixel SPX and control a driving current Ids flowing through the light emitting element LE.

The driving transistor DT includes a gate electrode, a first electrode, and a second electrode. The driving transistor DT controls a drain-source current Ids (hereinafter, referred to as a “driving current”) flowing between the first electrode and the second electrode according to a data voltage applied to the gate electrode.

The light emitting element LE may be a micro-LED.

The light emitting element LE emits light according to the driving current Ids. The amount of light emitted from the light emitting element LE may be proportional to the driving current Ids. An anode electrode of the light emitting element LE may be connected to a first electrode of the fourth transistor ST4 and a second electrode of the sixth transistor ST6, and a cathode electrode may be connected to a second power line VSL to which the second power supply voltage VSS is applied.

The capacitor C1 is formed between the gate electrode of the driving transistor DT and a first power line VDL to which the first power supply voltage VDD is applied. The first power supply voltage VDD may be at a higher level than the second power supply voltage VSS. One electrode of the capacitor C1 may be connected to the gate electrode of the driving transistor DT, and the other electrode may be connected to the first power line VDL.

As illustrated in FIG. 4, the first through sixth transistors ST1 through ST6 and the driving transistor DT may all be formed as p-type metal-oxide-semiconductor field effect transistors (MOSFETs). In this case, an active layer of each of the first through sixth transistors ST1 through ST6 and the driving transistor DT may be made of polysilicon.

A gate electrode of the first transistor ST1 and a gate electrode of the second transistor ST2 may be connected to the write scan line GWL, a gate electrode of the third transistor ST3 may be connected to the initialization scan line GIL, a gate electrode of the fourth transistor ST4 may be connected to the bias scan line GBL, and a gate electrode of the fifth transistor ST5 and a gate electrode of the sixth transistor ST6 may be connected to the emission control line EL. Because, the first through sixth transistors ST1 through ST6 are formed as p-type MOSFETs, they may be turned on when a scan signal of a gate-low voltage and an emission control signal of a gate-low voltage are transmitted to the initialization scan line GIL, the write scan line GWL, the bias scan line GBL, and the emission control line EL. One electrode of the third transistor ST3 may be connected to a first initialization voltage line VIL to which the third power supply voltage VINT is applied, and one electrode of the fourth transistor ST4 may be connected to a second initialization voltage line VAIL to which the fourth power supply voltage VAINT is applied. The third power supply voltage VINT and the fourth power supply voltage VAINT may be different voltages. In addition, the third power supply voltage VINT and the fourth power supply voltage VAINT may be at a lower level than the first power supply voltage VDD and may be at a higher level than the second power supply voltage VSS.

Alternatively, the driving transistor DT, the second transistor ST2, the fourth transistor ST4, the fifth transistor ST5, and the sixth transistor ST6 may be formed as p-type MOSFETs, and the first transistor ST1 and the third transistor ST3 may be formed as n-type MOSFETs. In this case, the active layer of each of the driving transistor DT, the second transistor ST2, the fourth transistor ST4, the fifth transistor ST5, and the sixth transistor ST6 formed as p-type MOSFETs may be made of polysilicon, and the active layer of each of the first transistor ST1 and the third transistor ST3 formed as n-type MOSFETs may be made of an oxide semiconductor. In addition, because the first transistor ST1 and the third transistor ST3 are formed as n-type MOSFETs, the first transistor ST1 may be turned on in response to a write scan signal of a gate-high voltage, and the third transistor ST3 may be turned on in response to an initialization scan signal of a gate-high voltage. On the other hand, because the second transistor ST2, the fourth transistor ST4, the fifth transistor ST5, and the sixth transistor ST6 are formed as p-type MOSFETs, they may be turned on in response to a scan signal of a gate-low voltage and an emission control signal of a gate-low voltage.

Alternatively, the fourth transistor ST4 may be formed as an n-type MOSFET, and the other transistors DT, ST1, ST2, ST3, ST5 and ST6 may be formed as p-type MOSFETs. In this case, the active layer of the fourth transistor ST4 may be made of an oxide semiconductor, and the active layer of each of the other transistors DT, ST1, ST2, ST3, ST5 and ST6 may be made of polysilicon. In addition, the fourth transistor ST4 may be turned on in response to a bias scan signal of a gate-high voltage, and the other transistors DT, ST1, ST2, ST3, ST5 and ST6 may be turned on in response to a scan signal of a gate-low voltage and an emission control signal of a gate-low voltage.

Alternatively, the first through sixth transistors ST1 through ST6 and the driving transistor DT may all be formed as n-type MOSFETs. In this case, the first through sixth transistors ST1 through ST6 and the driving transistor DT may each have an active layer made of an oxide semiconductor and may be turned on in response to a scan signal of a gate-high voltage and an emission control signal of a gate-high voltage.

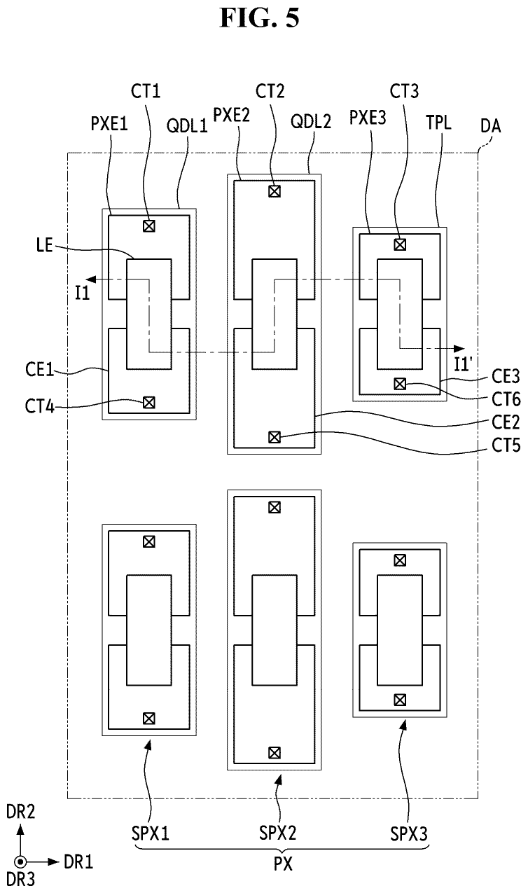

FIG. 5 is a layout view illustrating pixels of a display area according to one or more embodiments.

Referring to FIG. 5, each of the pixels PX in the display area DA may include three subpixels SPX1 through SPX3. However, the present disclosure is not limited thereto, and each of the pixels PX may also include four subpixels. When each of the pixels PX includes three subpixels SPX1 through SPX3, it may include a first subpixel SPX1, a second subpixel SPX2, and a third subpixel SPX3.

The pixels PX may be arranged in a matrix form. In each of the pixels PX, the first subpixel SPX1, the second subpixel SPX2, and the third subpixel SPX3 may be arranged along the first direction DR1.

When each of the pixels PX includes three subpixels SPX1 through SPX3, the first subpixel SPX1 may output first light, the second subpixel SPX2 may output second light, and the third subpixel SPX3 may output third light. Here, the first light may be light in a red wavelength band, the second light may be light in a green wavelength band, and the third light may be light in a blue wavelength band. For example, the blue wavelength band may indicate that a main peak wavelength of light is included in a wavelength band of about 370 to 460 nm, the green wavelength band may indicate that a main peak wavelength of light is included in a wavelength band of about 480 to 560 nm, and the red wavelength band may indicate that a main peak wavelength of light is included in a wavelength band of about 600 to 750 nm.

Alternatively, when each of the pixels PX includes four subpixels, one subpixel may output first light, another subpixel may output third light, and the other two subpixels may output second light. Alternatively, the four subpixels may output first light, second light, third light, and fourth light, respectively. Here, the fourth light may be white light.

The first subpixel SPX1 includes a first pixel electrode PXE1 and a light emitting element LE. When the light emitting element LE of the first subpixel SPX1 is a flip type or lateral type micro-LED, the first subpixel SPX1 may further include a first common electrode CE1 spaced (e.g., spaced apart) from the first pixel electrode PXE1. In one or more embodiments, the first pixel electrode PXE1 and the first common electrode CE1 may be spaced (e.g., spaced apart) from each other in the second direction DR2 and may each have a rectangular planar shape. However, the present disclosure is not limited thereto. For example, the arrangement structure, shapes, and/or sizes of the first pixel electrode PXE1 and the first common electrode CE1 may vary according to embodiments. The light emitting element LE of the first subpixel SPX1 may be disposed on the first pixel electrode PXE1 and the first common electrode CE1.

In one or more embodiments, when the light emitting element LE of the first subpixel SPX1 is a vertical type micro-LED, the first subpixel SPX1 may include a common electrode disposed on the first pixel electrode PXE1 and the light emitting element LE (e.g., a common electrode formed in the entire display area DA). For example, when the light emitting element LE of the first subpixel SPX1 is a vertical type micro-LED, the first subpixel SPX1 may include the first pixel electrode PXE1, the light emitting element LE, and the common electrode sequentially disposed along the third direction DR3.

The second subpixel SPX2 includes a second pixel electrode PXE2 and a light emitting element LE. When the light emitting element LE of the second subpixel SPX2 is a flip type or lateral type micro-LED, the second subpixel SPX2 may further include a second common electrode CE2 spaced (e.g., spaced apart) from the second pixel electrode PXE2. In one or more embodiments, the second pixel electrode PXE2 and the second common electrode CE2 may be spaced (e.g., spaced apart) from each other in the second direction DR2 and may each have a rectangular planar shape. However, the present disclosure is not limited thereto. For example, the arrangement structure, shapes, and/or sizes of the second pixel electrode PXE2 and the second common electrode CE2 may vary according to embodiments. The light emitting element LE of the second subpixel SPX2 may be disposed on the second pixel electrode PXE2 and the second common electrode CE2.

In one or more embodiments, when the light emitting element LE of the second subpixel SPX2 is a vertical type micro-LED, the second subpixel SPX2 may include a common electrode disposed on the second pixel electrode PXE2 and the light emitting element LE (e.g., a common electrode formed in the entire display area DA). For example, when the light emitting element LE of the second subpixel SPX2 is a vertical type micro-LED, the second subpixel SPX2 may include the second pixel electrode PXE2, the light emitting element LE, and the common electrode sequentially disposed along the third direction DR3.

The third subpixel SPX3 includes a third pixel electrode PXE3 and a light emitting element LE. When the light emitting element LE of the third subpixel SPX3 is a flip type or lateral type micro-LED, the third subpixel SPX3 may further include a third common electrode CE3 spaced (e.g., spaced apart) from the third pixel electrode PXE3. In one or more embodiments, the third pixel electrode PXE3 and the third common electrode CE3 may be spaced (e.g., spaced apart) from each other in the second direction DR2 and may each have a rectangular planar shape. However, the present disclosure is not limited thereto. For example, the arrangement structure, shapes, and/or sizes of the third pixel electrode PXE3 and the third common electrode CE3 may vary according to embodiments. The light emitting element LE of the third subpixel SPX3 may be disposed on the third pixel electrode PXE3 and the third common electrode CE3.

In one or more embodiments, when the light emitting element LE of the third subpixel SPX3 is a vertical type micro-LED, the third subpixel SPX3 may include a common electrode disposed on the third pixel electrode PXE3 and the light emitting element LE (e.g., a common electrode formed in the entire display area DA). For example, when the light emitting element LE of the third subpixel SPX3 is a vertical type micro-LED, the third subpixel SPX3 may include the third pixel electrode PXE3, the light emitting element LE, and the common electrode sequentially disposed along the third direction DR3.

In FIG. 5, an embodiment in which each of the first subpixel SPX1, the second subpixel SPX2, and the third subpixel SPX3 includes one light emitting element LE is disclosed. However, the present disclosure is not limited thereto. For example, at least one of the first subpixel SPX1, the second subpixel SPX2, and/or the third subpixel SPX3 may also include a plurality of light emitting elements LE.

In one or more embodiments, the first subpixel SPX1, the second subpixel SPX2, and the third subpixel SPX3 may include light emitting elements LE which emit third light. In addition, the first subpixel SPX1 may include a first light conversion layer QDL1 for converting third light into first light, the second subpixel SPX2 may include a second light conversion layer QDL2 for converting third light into second light, and the third subpixel SPX3 may include a light transmission layer TPL (or a third light conversion layer), which transmits third light. In one or more embodiments, the area of the first subpixel SPX1, the area of the second subpixel SPX2, and the area of the third subpixel SPX3 may be set according to the light conversion efficiency of the first light conversion layer QDL1 and the light conversion efficiency of the second light conversion layer QDL2. For example, the lower the light conversion efficiency, the larger the area of a subpixel (e.g., the area of an emission area).

For example, when the light conversion efficiency of the second light conversion layer QDL2 is lower than the light conversion efficiency of the first light conversion layer QDL1, the area of the second pixel electrode PXE2 and the area of the second common electrode CE2 may be larger than the area of the first pixel electrode PXE1 and the area of the first common electrode CE1 as illustrated in FIG. 5. In addition, because the first light conversion layer QDL1 converts light whereas the light transmission layer TPL transmits light of the light emitting elements LE as it is, the area of the first pixel electrode PXE1 and the area of the first common electrode CE1 may be larger than the area of the third pixel electrode PXE3 and the area of the third common electrode CE3.

Each of the pixel electrodes PXE1 through PXE3 may be electrically connected to at least one transistor through a pixel connection hole CT1/CT2/CT3. For example, each of the first pixel electrode PXE1, the second pixel electrode PXE2, and the third pixel electrode PXE3 may be electrically connected to a first electrode of the fourth transistor ST4 (see FIG. 4) and the second electrode of the sixth transistor ST6 (see FIG. 4) of a corresponding subpixel SPX through a first pixel connection hole CT1, a second pixel connection hole CT2, or a third pixel connection hole CT3.

Each of the common electrodes CE1 through CE3 may be connected to the second power line VSL through a common connection hole CT4/CT5/CT6. For example, the first common electrode CE1, the second common electrode CE2, and the third common electrode CE3 may be connected to the second power line VSL through a first common connection hole CT4, a second common connection hole CT5, and a third common connection hole CT5, respectively. Accordingly, the second power supply voltage VSS may be applied to the common electrodes CE1 through CE3.

The light emitting elements LE of the subpixels SPX1 through SPX3 may emit third light, for example, light in the blue wavelength band, but the present disclosure is not limited thereto. If the light emitting element LE of the first subpixel SPX1 emits first light, the light emitting element LE of the second subpixel SPX2 emits second light, and the light emitting element LE of the third subpixel SPX3 emits third light, the light conversion layers QDL1 and QDL2 and the light transmission layer TPL may be omitted. For example, each of the first subpixel SPX1, the second subpixel SPX2, and the third subpixel SPX3 may or may not include the first light conversion layer QDL1, the second light conversion layer QDL2, or the light transmission layer TPL depending on whether the color and/or wavelength of light emitted from the light emitting element LE is to be converted and/or depending on luminous efficiency.

The first light conversion layer QDL1 may completely overlap the first pixel electrode PXE1, the light emitting element LE, and the first common electrode CE1 of the first subpixel SPX1. The area of the first light conversion layer QDL1 may be larger than the area of the first pixel electrode PXE1, the light emitting element LE, and/or the first common electrode CE1 of the first subpixel SPX1. The first light conversion layer QDL1 may convert and/or shift a peak wavelength of incident light into another specific peak wavelength and output light of the specific peak wavelength. For example, the first light conversion layer QDL1 may convert or shift third light emitted from the light emitting element LE of the first subpixel SPX1 into first light.

The second light conversion layer QDL2 may completely overlap the second pixel electrode PXE2, the light emitting element LE, and the second common electrode CE2 of the second subpixel SPX2. The area of the second light conversion layer QDL2 may be larger than the area of the second pixel electrode PXE2, the light emitting element LE, and/or the second common electrode CE2 of the second subpixel SPX2. The second light conversion layer QDL2 may convert and/or shift a peak wavelength of incident light into another specific peak wavelength and output light of the specific peak wavelength. For example, the second light conversion layer QDL2 may convert and/or shift third light emitted from the light emitting element LE of the second subpixel SPX2 into second light.

The light transmission layer TPL may completely overlap the third pixel electrode PXE3, the light emitting element LE, and the third common electrode CE3 of the third subpixel SPX3. The light transmission layer TPL may transmit incident light as it is. For example, the light transmission layer TPL may transmit third light emitted from the light emitting element LE of the third subpixel SPX3 as it is.

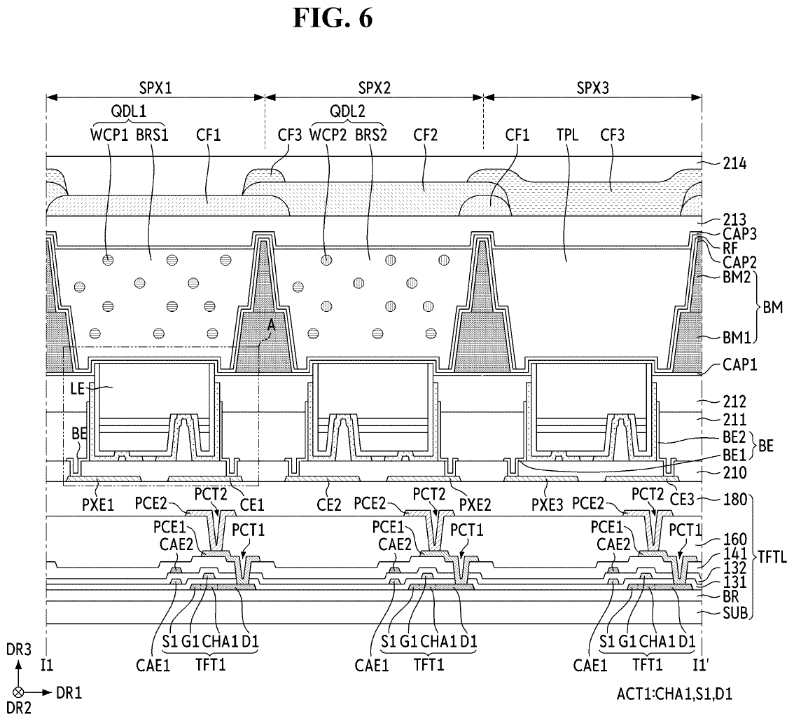

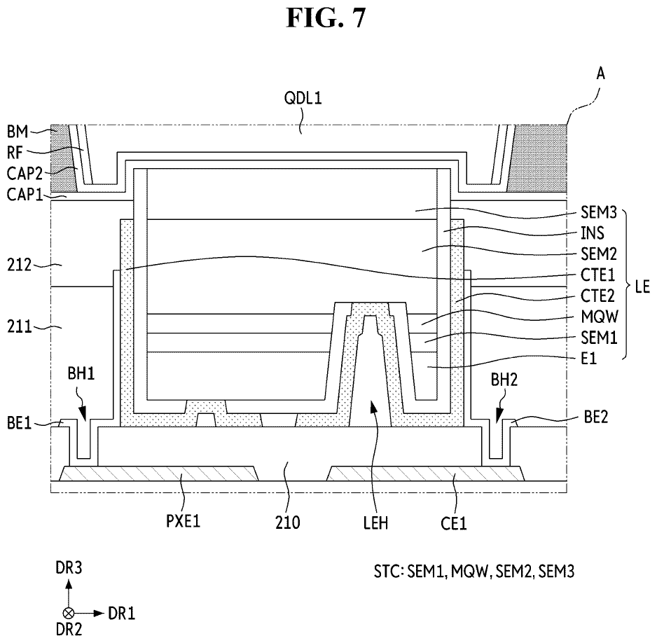

FIG. 6 is a cross-sectional view illustrating an example of a cross section of a display panel corresponding to the line I1-I1′ of FIG. 5. FIG. 7 is a detailed cross-sectional view of an example of an area A of FIG. 6.

Referring to FIGS. 6 and 7, a substrate SUB may be made of an insulating material such as glass and/or polymer resin. When the substrate SUB is made of polymer resin, it may be a flexible substrate that can be stretched. The polymer resin may be acryl resin, epoxy resin, phenolic resin, polyamide resin, and/or polyimide resin.

A barrier layer BR may be disposed on the substrate SUB. The barrier layer BR is a layer for protecting transistors of a thin-film transistor layer TFTL and light emitting elements LE disposed on the thin-film transistor layer TFTL from moisture introduced through the substrate SUB, which is vulnerable to moisture penetration. The barrier layer BR may be composed of a plurality of inorganic layers stacked alternately.

Thin-film transistors TFT1 may be disposed on the barrier layer BR. Each of the thin-film transistors TFT1 may be one of the fourth transistor ST4 and the sixth transistor ST6 illustrated in FIG. 4. Each of the thin-film transistors TFT1 may include a first active layer ACT1 and a first gate electrode G1.

The first active layer ACT1 of each of the thin-film transistors TFT1 may be disposed on the barrier layer BR. The first active layer ACT1 of each of the thin-film transistors TFT1 may include polycrystalline silicon, monocrystalline silicon, low-temperature polycrystalline silicon, and/or amorphous silicon. Alternatively, the first active layer ACT1 of each of the thin-film transistors TFT1 may be made of an oxide semiconductor including IGZO (indium (In), gallium (Ga), zinc (Zn) and oxygen (O)), IGZTO (indium (In), gallium (Ga), zinc (Zn), tin (Sn) and oxygen (O)), and/or IGTO (indium (In), gallium (Ga), tin (Sn) and oxygen (O)).

The first active layer ACT1 may include a first channel region CHA1, a first source region S1, and a first drain region D1. The first channel region CHA1 may be a region overlapped by the first gate electrode G1 in the third direction DR3 which is the thickness direction of the substrate SUB. The first source region S1 may be disposed on a side of the first channel region CHA1, and the first drain region D1 may be disposed on the other side of the first channel region CHA1. The first source region S1 and the first drain region D1 may be regions not overlapped by the first gate electrode G1 in the third direction DR3. The first source region S1 and the first drain region D1 may be regions formed to have conductivity by doping a semiconductor material with ions.

A first gate insulating layer 131 may be disposed on the first channel regions CHA1, the first source regions S1, and the first drain regions D1 of the thin-film transistors TFT1 and the barrier layer BR.

A first gate metal layer may be disposed on the first gate insulating layer 131. The first gate metal layer may include the first gate electrodes G1 of the thin-film transistors TFT1 and first capacitor electrodes CAE1. The first gate electrodes G1 may overlap the first active layers ACT1 in the third direction DR3. In FIG. 6, the first gate electrodes G1 and the first capacitor electrodes CAE1 are spaced (e.g., spaced apart) from each other. However, when each of the thin-film transistors TFT1 is the driving transistor DT of FIG. 4, the first gate electrodes G1 and the first capacitor electrodes CAE1 may be electrically or physically connected to each other. Alternatively, when each of the thin-film transistors TFT1 is one of the first through sixth transistors ST1 through ST6 of FIG. 4, the first gate electrodes G1 and the first capacitor electrodes CAE1 may not be electrically or physically connected to each other.

A second gate insulating layer 132 may be disposed on the first gate electrodes G1 of the thin-film transistors TFT1, the first capacitor electrodes CAE1, and the first gate insulating layer 131.

A second gate metal layer may be disposed on the second gate insulating layer 132. The second gate metal layer may include second capacitor electrodes CAE2. The second capacitor electrodes CAE2 may overlap the first capacitor electrodes CAE1 in the third direction DR3. Because the second gate insulating layer 132 has a suitable dielectric constant (e.g., a predetermined dielectric constant), capacitors C1 (see FIG. 4) may be formed by the first capacitor electrodes CAE1, the second capacitor electrodes CAE2, and the second gate insulating layer 132 disposed between them.

A first interlayer insulating layer 141 may be disposed on the second capacitor electrodes CAE2 and the second gate insulating layer 132.

A first data metal layer may be disposed on the interlayer insulating layer 141. The first data metal layer may include first source connection electrodes PCE1. The first source connection electrodes PCE1 may be connected to the first drain regions D1 of the first active layers ACT1 through first source contact holes PCT1 penetrating the first gate insulating layer 131, the second gate insulating layer 132, and the interlayer insulating layer 141.

A first planarization layer 160 may be disposed on the first source connection electrodes PCE1 and the interlayer insulating layer 141 to flatten steps caused by the thin-film transistors TFT1.

A second data metal layer may be disposed on the first planarization layer 160. The second data metal layer may include second source connection electrodes PCE2. The second source connection electrodes PCE2 may be connected to the first source connection electrodes PCE1 through second source contact holes PCT2 penetrating the first planarization layer 160.

A second planarization layer 180 may be disposed on the second source connection electrodes PCE2 and the first planarization layer 160.

The barrier layer BR, the first gate insulating layer 131, the second gate insulating layer 132, and the interlayer insulating layer 141 may be made of an inorganic layer, for example, silicon nitride (SiNₓ), silicon oxynitride (SiON), silicon oxide (SiOₓ), titanium oxide (TiOₓ), and/or aluminum oxide (AlOₓ).

The first gate metal layer, the second gate metal layer, the first data metal layer, and the second data metal layer may each be a single layer or a multilayer made of molybdenum (Mo), aluminum (Al), chromium (Cr), gold (Au), titanium (Ti), nickel (Ni), neodymium (Nd), copper (Cu), and/or alloys thereof.

The first planarization layer 160 and the second planarization layer 180 may be made of an organic layer such as acryl resin, epoxy resin, phenolic resin, polyamide resin, and/or polyimide resin.

A light emitting element layer may be disposed on the second planarization layer 180. The light emitting element layer may include pixel electrodes PXE1 through PXE3, common electrodes CE1 through CE3, light emitting elements LE, and organic layers 210, 211, and 212.

A pixel electrode layer may be disposed on the second planarization layer 180. The pixel electrode layer may include a first pixel electrode PXE1, a second pixel electrode PXE2, and a third pixel electrode PXE3. In one or more embodiments, each of the light emitting elements LE may be a flip type micro-LED. The flip type micro-LED refers to an LED in which contact electrodes CTE1 and CTE2 are formed on a surface (e.g., a lower surface) of a light emitting element LE. When the light emitting elements LE are flip type micro-LEDs, the pixel electrode layer may further include a first common electrode CE1, a second common electrode CE2, and a third common electrode CE3.

Each of the pixel electrodes PXE1 through PXE3 may be connected to a second source connection electrode PCE2 through a pixel connection hole CT1/CT2/CT3 (see FIG. 5) penetrating the second planarization layer 180. Each of the pixel electrodes PXE1 through PXE3 may be connected to the first source region S1 or the first drain region D1 of a thin-film transistor TFT1 through a first source connection electrode PCE1 and a second source connection electrode PCE2. Therefore, a voltage controlled by a thin-film transistor TFT1 may be applied to each of the pixel electrodes PXE1 through PXE3.

The pixel electrode layer may be a single layer or a multilayer made of molybdenum (Mo), aluminum (Al), chromium (Cr), gold (Au), titanium (Ti), nickel (Ni), neodymium (Nd), copper (Cu), and/or alloys thereof. For example, the pixel electrode layer may be made of copper (Cu) with low sheet resistance in order to lower the resistance of each of the pixel electrodes PXE1 through PXE3 and the common electrodes CE1 through CE3.

A first organic layer 210 may be disposed on the pixel electrodes PXE1 through PXE3, the common electrodes CE1 through CE3, and the second planarization layer 180. The first organic layer 210 temporarily fixes or attaches a plurality of light emitting elements LE to prevent the light emitting elements LE from tilting or falling during a process of transferring the light emitting elements LE to the display panel 100. That is, the first organic layer 210 may be a layer for temporarily attaching a plurality of light emitting elements LE onto the pixel electrodes PXE1 through PXE3 and the common electrodes CE1 through CE3. To facilitate the temporary adhesion, the first organic layer 210 may be thicker than each of the pixel electrodes PXE1 through PXE3 and the common electrodes CE1 through CE3 and thicker than each of the contact electrodes CTE1 and CTE2 of the light emitting elements LE.

The first organic layer 210 may be a photosensitive organic layer such as photoresist. Alternatively, the first organic layer 210 may be made of acryl resin, epoxy resin, phenolic resin, polyamide resin, and/or polyimide resin.

The light emitting elements LE may be disposed on the first organic layer 210. Each of the light emitting elements LE may be made of an inorganic material such as gallium nitride (GaN). Each of the light emitting elements LE may have a length of several to hundreds of μm in each of the first direction DR1, the second direction DR2, and the third direction DR3. For example, each of the light emitting elements LE may have a length of about 100 μm or less in each of the first direction DR1, the second direction DR2, and the third direction DR3.

The light emitting elements LE may be grown on a semiconductor substrate such as a silicon substrate and/or a sapphire substrate. The light emitting elements LE may be directly transferred from the semiconductor substrate onto the pixel electrodes PXE1 through PXE3 and the common electrodes CE1 through CE3 of the display panel 100. Alternatively, the light emitting elements LE may be transferred onto the pixel electrodes PXE1 through PXE3 and the common electrodes CE1 through CE3 of the display panel 100 through an electrostatic method using an electrostatic head or a stamp method using an elastic polymer material, such as PDMS or silicon, as a transfer substrate.

Each of the light emitting elements LE may include a conductive layer E1, a semiconductor stack STC, contact electrodes CTE1 and CTE2, and a protective layer INS. The semiconductor stack STC may include a first semiconductor layer SEM1, an active layer MQW, and a second semiconductor layer SEM2 sequentially disposed along the third direction DR3 (e.g., a thickness direction of the substrate SUB. In one or more embodiments, the semiconductor stack STC may further include a third semiconductor layer SEM3 on the second semiconductor layer SEM2.

The conductive layer E1 may be disposed on a lower surface of the first semiconductor layer SEM1. Although the conductive layer E1 covers the entire lower surface of the first semiconductor layer SEM1 in FIG. 7, the present disclosure is not limited thereto. For example, the conductive layer E1 may also be disposed on a portion of the lower surface of the first semiconductor layer SEM1. The conductive layer E1 may include molybdenum (Mo), aluminum (Al), chromium (Cr), gold (Au), titanium (Ti), nickel (Ni), neodymium (Nd), and/or copper (Cu).

The first semiconductor layer SEM1 may be disposed on the conductive layer E1. The first semiconductor layer SEM1 may be made of a semiconductor material layer, for example, gallium nitride (GaN) doped with a first conductivity type dopant such as magnesium (Mg), zinc (Zn), calcium (Ca), strontium (Sr), and/or barium (Ba).

The active layer MQW may be disposed on the first semiconductor layer SEM1. The active layer MQW may include the same semiconductor material as the first semiconductor layer SEM1 and the second semiconductor layer SEM2. For example, when the first semiconductor layer SEM1 and the second semiconductor layer SEM2 include gallium nitride (GaN), the active layer MQW may also include gallium nitride (GaN). For example, the active layer MQW may include gallium nitride (GaN), indium gallium nitride (InGaN), and/or aluminum gallium nitride (AlGaN). The active layer MQW may emit light through combination of electron-hole pairs according to electrical signals received through the first semiconductor layer SEM1 and the second semiconductor layer SEM2.

The active layer MQW may include a material having a single or multiple quantum well structure. When the active layer MQW includes a material having a multiple quantum well structure, it may be a structure in which a plurality of well layers and a plurality of barrier layers are alternately stacked. Here, the well layers may be made of InGaN, and the barrier layers may be made of GaN and/or AlGaN, but the present disclosure is not limited thereto. Alternatively, the active layer MQW may be a structure in which a semiconductor material having a large band gap energy and a semiconductor material having a small band gap energy are alternately stacked or may include different group III to V semiconductor materials depending on the wavelength band of light that it emits.

When the active layer MQW includes indium gallium nitride (InGaN), the color of light that it emits may vary according to indium content. For example, as the indium (In) content increases, the wavelength band of light emitted from the active layer MQW may move to the red wavelength band, and as the indium (In) content decreases, the wavelength band of light emitted from the active layer MQW may move to the blue wavelength band. For example, the indium content of the active layer MQW of a light emitting element LE that emits third light (e.g., light in the blue wavelength band) may be about 10 to 20 wt %.

The second semiconductor layer SEM2 may be disposed on the active layer MQW. The second semiconductor layer SEM2 may be made of a semiconductor material layer, for example, gallium nitride (GaN) doped with a second conductivity type dopant such as silicon (Si), germanium (Ge), and/or tin (Sn).

The third semiconductor layer SEM3 may be disposed on the second semiconductor layer SEM2. The third semiconductor layer SEM3 may be a semiconductor material layer having an n-type dopant lower than a suitable threshold value (e.g., a predetermined threshold value) and may be referred to as an undoped semiconductor layer. For example, the third semiconductor layer SEM3 may be indium aluminum gallium nitride (InAlGaN), gallium nitride (GaN), aluminum gallium nitride (AlGaN), indium gallium nitride (InGaN), aluminum nitride (AlN), and/or indium nitride (InN) having an n-type dopant lower than a suitable threshold value (e.g., a predetermined threshold value).

An electron blocking layer may be disposed between the first semiconductor layer SEM1 and the active layer MQW. The electron blocking layer may be a layer for suppressing or preventing too many electrons from flowing into the active layer MQW. For example, the electron blocking layer may be AlGaN and/or p-AlGaN doped with p-type Mg. The electron blocking layer can be omitted.

A superlattice layer may be disposed between the active layer MQW and the second semiconductor layer SEM2. The superlattice layer may be a layer for relieving stress between the second semiconductor layer SEM2 and the active layer MQW. For example, the superlattice layer may be made of InGaN and/or GaN. The superlattice layer can be omitted.

The protective layer INS may be disposed on side surfaces (e.g., outer peripheral surfaces) of the first semiconductor layer SEM1, side surfaces (e.g., outer peripheral surfaces) of the active layer MQW, and side surfaces (e.g., outer peripheral surfaces) of the second semiconductor layer SEM2. The protective layer INS may also be disposed on the side surfaces (e.g., outer peripheral surfaces) of the conductive layer E1 and the third semiconductor layer SEM3. The protective layer INS may be a layer for protecting side surfaces (e.g., outer peripheral surfaces) of each light emitting element LE. The protective layer INS may be made of an inorganic layer, for example, silicon nitride (SiNₓ), silicon oxynitride (SiON), silicon oxide (SiOₓ), titanium oxide (TiOₓ), and/or aluminum oxide (AlOₓ).

In FIG. 7, the protective layer INS is disposed on the side surfaces (e.g., outer peripheral surfaces) of the conductive layer E1, the side surfaces (e.g., outer peripheral surfaces) of the first semiconductor layer SEM1, the side surfaces (e.g., outer peripheral surfaces) of the active layer MQW, the side surfaces (e.g., outer peripheral surfaces) of the second semiconductor layer SEM2, and the side surfaces (e.g., outer peripheral surfaces) of the third semiconductor layer SEM3 of the semiconductor stack STC. However, the present disclosure is not limited thereto. For example, in one or more embodiments, the protective layer INS may be disposed on the side surfaces (e.g., outer peripheral surfaces) of the first semiconductor layer SEM1, the side surfaces (e.g., outer peripheral surfaces) of the active layer MQW, and the side surfaces (e.g., outer peripheral surfaces) of the second semiconductor layer SEM2 of the semiconductor stack STC, and may not disposed on the side surfaces (e.g., outer peripheral surfaces) of the third semiconductor layer SEM3 and the conductive layer E1.

A hole LEH may be formed to pass through the conductive layer E1, the first semiconductor layer SEM1, and the active layer MQW of each light emitting element LE and expose the second semiconductor layer SEM2. The hole LEH may have a circular planar shape, but the present disclosure is not limited thereto. For example, the hole LEH may also have an elliptical planar shape or a polygonal planar shape such as a quadrangle.

In addition, the protective layer INS may be disposed on sidewalls of the conductive layer E1, sidewalls of the first semiconductor layer SEM1, and sidewalls of the active layer MQW exposed in the hole LEH. The protective layer INS may not cover the second semiconductor layer SEM2 in the hole LEH. Therefore, the second semiconductor layer SEM2 may be exposed without being covered by the protective layer INS.

A first contact electrode CTE1 may be disposed on at least one side surface of the semiconductor stack STC and on at least one side surface and a lower surface of the conductive layer E1. The first contact electrode CTE1 may be disposed on the lower surface (e.g., a portion of the lower surface) of the conductive layer E1, which is exposed without being covered by the protective layer INS. Therefore, the first contact electrode CTE1 may be electrically connected to the conductive layer E1.

A second contact electrode CTE2 may be disposed on at least one side surface of the semiconductor stack STC and on at least one side surface and the lower surface of the conductive layer E1. Here, while the first contact electrode CTE1 is disposed on a first side surface of the semiconductor stack STC and a first side surface of the conductive layer E1, the second contact electrode CTE2 may be disposed on a second side surface of the semiconductor stack STC and a second side surface of the conductive layer E1.

The second contact electrode CTE2 may be disposed on the protective layer INS disposed in the hole LEH and the second semiconductor layer SEM2 exposed in the hole LEH without being covered by the protective layer INS. Therefore, the second contact electrode CTE2 may be electrically connected to the second semiconductor layer SEM2 in the hole LEH.

In FIGS. 6 and 7, the first contact electrode CTE1 and the second contact electrode CTE2 of each light emitting element LE are disposed on the first organic layer 210, but the present disclosure is not limited thereto. For example, the first organic layer 210 may also be disposed on a lower surface and a portion of a side surface of the first contact electrode CTE1 and a lower surface and a portion of a side surface of the second contact electrode CTE2 of each light emitting element LE. Alternatively, the first organic layer 210 may be disposed on the side surfaces of the conductive layer E1 of each light emitting element LE. Alternatively, the first organic layer 210 may be disposed on the side surfaces of the first semiconductor layer SEM1, the side surfaces of the active layer MQW, and the side surfaces of the second semiconductor layer SEM2 of each light emitting element LE. In this case, the first organic layer 210 may be disposed on a portion of each side surface of the second semiconductor layer SEM2.

The first contact electrode CTE1 and the second contact electrode CTE2 may be disposed on three side surfaces of the semiconductor stack STC. For example, when the semiconductor stack STC includes first through fourth side surfaces, the first contact electrode CTE1 may be disposed on the first side surface and the third side surface, and the second contact electrode CTE2 may be disposed on the second side surface and the third side surface. In one or more embodiments, each of the first contact electrode CTE1 and the second contact electrode CTE2 may be disposed on three side surfaces of the semiconductor stack STC. For example, when the semiconductor stack STC includes first through fourth side surfaces, the first contact electrode CTE1 may be disposed on the first side surface, the second side surface and the third side surface, and the second contact electrode CTE2 may be disposed on the second side surface, the third side surface and the fourth side surface.

Each of the first contact electrode CTE1 and the second contact electrode CTE2 may include molybdenum (Mo), aluminum (Al), chromium (Cr), gold (Au), titanium (Ti), nickel (Ni), neodymium (Nd), and/or copper (Cu). In one or more embodiments, to increase reflectivity, each of the first contact electrode CTE1 and the second contact electrode CTE2 may have a two-layer structure of chromium (Cr) and gold (Au), a three-layer structure of titanium (Ti), aluminum (Al) and titanium (Ti), or a three-layer structure of indium tin oxide (ITO), silver (Ag) and indium tin oxide (ITO).

When each of the first contact electrode CTE1 and the second contact electrode CTE2 is made of a metal with high reflectivity, light travelling in a lateral direction of each light emitting element LE from among light emitted from the active layer MQW of the light emitting element LE may be reflected by the first contact electrode CTE1 and the second contact electrode CTE2 to exit from an upper surface of the light emitting element LE. Accordingly, a loss of light of the light emitting element LE can be reduced, and thus the light efficiency of the light emitting element LE can be increased. Therefore, in order to increase the light efficiency of each light emitting element LE, each of the first contact electrode CTE1 and the second contact electrode CTE2 may cover most of the side surfaces of the semiconductor stack STC.

A first connection electrode BE1 connects the first contact electrode CTE1 of each light emitting element LE to a pixel electrode PXE1/PXE2/PXE3. The first connection electrode BE1 may be connected to the pixel electrode PXE1/PXE2/PXE3 exposed through a first connection hole BH1 penetrating the first organic layer 210. In addition, the first connection electrode BE1 may be disposed on an upper surface of the first organic layer 210 and the first contact electrode CTE1.

A second connection electrode BE2 connects the second contact electrode CTE2 of each light emitting element LE to a common electrode CE1/CE2/CE3. The second connection electrode BE2 may be connected to the common electrode CE1/CE2/CE3 exposed through a second connection hole BH2 penetrating the first organic layer 210. In addition, the second connection electrode BE2 may be disposed on the upper surface of the first organic layer 210 and the second contact electrode CTE2.

Each of the first connection electrode BE1 and the second connection electrode BE2 may include molybdenum (Mo), aluminum (Al), chromium (Cr), gold (Au), titanium (Ti), nickel (Ni), neodymium (Nd), and/or copper (Cu). Alternatively, each of the first connection electrode BE1 and the second connection electrode BE2 may be made of a transparent conductive material (TCO) such as indium tin oxide (ITO) and/or indium zinc oxide (IZO).

When the connection electrodes BE (BE1, BE2) are made of a metal material with high reflectivity such as aluminum (Al), light travelling in the lateral direction of each light emitting element LE from among light emitted from the active layer MQW of the light emitting element LE may be reflected by the connection electrodes BE (BE1, BE2) toward the top of the light emitting element LE. Accordingly, a loss of light of the light emitting element LE can be reduced, and thus the light efficiency of the light emitting element LE can be increased.

As illustrated in FIGS. 6 and 7, the conductive layer E1 of each light emitting element LE may be connected to a pixel electrode PXE1/PXE2/PXE3 through the first contact electrode CTE1 and the first connection electrode BE1. In addition, the second semiconductor layer SEM2 of each light emitting element LE may be connected to a common electrode CE1/CE2/CE3 through the second contact electrode CTE2 formed in the hole LEH and the second connection electrode BE2. The pixel electrodes PXE1 through PXE3 may be referred to as anode electrodes or first electrodes, and the common electrodes CE1 through CE3 may be referred to as cathode electrodes or second electrodes.

A third organic layer 211 may partially cover the side surfaces of the light emitting elements LE. In addition, the third organic layer 211 may cover the connection electrodes BE, but at least a portion of each of the connection electrodes BE may be exposed without being covered by the third organic layer 211.

A fourth organic layer 212 may be disposed on the third organic layer 211. The fourth organic layer 212 may partially cover the side surfaces of each of the light emitting elements LE. The fourth organic layer 212 may be disposed on at least a portion of each of the connection electrodes BE exposed without being covered by the third organic layer 211. The upper surface of each of the light emitting elements LE may be exposed without being covered by the fourth organic layer 212.

The third organic layer 211 and the fourth organic layer 212 may be made of an organic layer such as acryl resin, epoxy resin, phenolic resin, polyamide resin, and/or polyimide resin.

The third organic layer 211 and the fourth organic layer 212 are layers for flattening steps caused by the light emitting elements LE. If the third organic layer 211 is high enough to cover most of the side surfaces of each of the light emitting elements LE, the fourth organic layer 212 may be omitted.

A first capping layer CAP1 may be disposed on the light emitting elements LE, the third organic layer 211, and the fourth organic layer 212.

A light blocking layer BM, a first light conversion layer QDL1, a second light conversion layer QDL2, and a light transmission layer TPL may be disposed on the first capping layer CAP1. The first light conversion layer QDL1, the second light conversion layer QDL2, and the light transmission layer TPL may be separated or partitioned by the light blocking layer BM. The first light conversion layer QDL1 may be disposed on the first capping layer CAP1 in a first subpixel SPX1, the second light conversion layer QDL2 may be disposed on the first capping layer CAP1 in a second subpixel SPX2, and the light transmission layer TPL may be disposed on the first capping layer CAP1 in a third subpixel SPX3. The light blocking layer BM may overlap the third organic layer 211 and the fourth organic layer 212 in the third direction DR3 and may not overlap the light emitting elements LE.

The first light conversion layer QDL1 may convert a portion of third light (e.g., light in the blue wavelength band) incident from a light emitting element LE into first light (e.g., light in the red wavelength band). The first light conversion layer QDL1 may include a first base resin BRS1 and first wavelength conversion particles WCP1. The first base resin BRS1 may include a light-transmitting organic material. The first wavelength conversion particles WCP1 may convert a portion of the third light (e.g., light in the blue wavelength band) incident from the light emitting element LE into the first light (e.g., light in the red wavelength band).

The second light conversion layer QDL2 may convert a portion of third light (e.g., light in the blue wavelength band) incident from a light emitting element LE into second light (e.g., light in the green wavelength band). The second light conversion layer QDL2 may include a second base resin BRS2 and second wavelength conversion particles WCP2. The second base resin BRS2 may include a light-transmitting organic material. The second wavelength conversion particles WCP2 may convert a portion of the third light (e.g., light in the blue wavelength band) incident from the light emitting element LE into the second light (e.g., light in the green wavelength band).

The light transmission layer TPL may include a light-transmitting organic material.

For example, the first base resin BRS1, the second base resin BRS2, and the light transmission layer TPL may include epoxy resin, acrylic resin, cardo resin, and/or imide resin. The first and second wavelength conversion particles WCP1 and WCP2 may be quantum dots, quantum rods, fluorescent materials, and/or phosphorescent materials.

The light blocking layer BM may include a first light blocking layer BM1 and a second light blocking layer BM2 stacked sequentially. A length of the first light blocking layer BM1 in the first direction DR1 and/or a length of the first light blocking layer BM1 in the second direction DR2 may be greater than a length of the second light blocking layer BM2 in the first direction DR1 and/or a length of the second light blocking layer BM2 in the second direction DR2. The first light blocking layer BM1 and the second light blocking layer BM2 may be made of an organic layer such as acryl resin, epoxy resin, phenolic resin, polyamide resin, and/or polyimide resin. The first light blocking layer BM1 and the second light blocking layer BM2 may include a light blocking material to prevent light of the light emitting element LE of any one subpixel from travelling to a neighboring subpixel. For example, the first light blocking layer BM1 and the second light blocking layer BM2 may include an inorganic black pigment such as carbon black and/or an organic black pigment.

A second capping layer CAP2 may be disposed on the first capping layer CAP1 and the light blocking layer BM. The second capping layer CAP2 may be disposed on side and upper surfaces of the light blocking layer BM. For example, the second capping layer CAP2 may be disposed on side surfaces of the first light blocking layer BM1 and side and upper surfaces of the second light blocking layer BM2.

A reflective layer RF may be disposed between the light blocking layer BM and the first light conversion layer QDL1, between the light blocking layer BM and the second light conversion layer QDL2, and between the light blocking layer BM and the light transmission layer TPL. The reflective layer RF may be disposed on the second capping layer CAP2 disposed on the side surfaces of the first light blocking layer BM1 and the side surfaces of the second light blocking layer BM2. The reflective layer RF may reflect light travelling in the lateral direction from the first light conversion layer QDL1, the second light conversion layer QDL2, and the light transmission layer TPL.

The reflective layer RF may include a metal material with high reflectivity, such as aluminum (Al). A thickness of the reflective layer RF may be about 0.1 μm.

Alternatively, to serve as distributed Bragg reflectors, the reflective layer RF may include M (M is an integer of 2 or more) pairs of first and second layers having different refractive indices. In this case, M first layers and M second layers may be arranged alternately. The first and second layers may be made of an inorganic layer, for example, silicon nitride (SiNₓ), silicon oxynitride (SiON), silicon oxide (SiOₓ), titanium oxide (TiOₓ), and/or aluminum oxide (AlOₓ).

A third capping layer CAP3 may be disposed on the second capping layer CAP2, the reflective layer RF, the first light conversion layer QDL1, the second light conversion layer QDL2, and the light transmission layer TPL.

The first capping layer CAP1, the second capping layer CAP2, and the third capping layer CAP3 may be made of an inorganic layer, for example, silicon nitride (SiNₓ), silicon oxynitride (SiON), silicon oxide (SiOₓ), titanium oxide (TiOₓ), and/or aluminum oxide (AlOₓ). The first light conversion layer QDL1, the second light conversion layer QDL2, and the light transmission layer TPL may be encapsulated by the first capping layer CAP1, the second capping layer CAP2, and the third capping layer CAP3.

A fifth organic layer 213 may be disposed on the third capping layer CAP3. A plurality of color filters CF1 through CF3 may be disposed on the fifth organic layer 213. The color filters CF1 through CF3 may include first color filters CF1, second color filters CF2, and third color filters CF3.

A first color filter CF1 disposed in the first subpixel SPX1 may transmit first light (e.g., light in the red wavelength band) and absorb or block third light (e.g., light in the blue wavelength band). Therefore, the first color filter CF1 may transmit the first light (e.g., light in the red wavelength band) into which a portion of the third light (e.g., light in the blue wavelength band) emitted from a light emitting element LE has been converted by the first light conversion layer QDL1 and may absorb or block the third light (e.g., light in the blue wavelength band), which has not been converted by the first light conversion layer QDL1. Accordingly, the first subpixel SPX1 may output the first light (e.g., light in the red wavelength band).

A second color filter CF2 disposed in the second subpixel SPX2 may transmit second light (e.g., light in the green wavelength band) and absorb or block third light (e.g., light in the blue wavelength band). Therefore, the second color filter CF2 may transmit the second light (e.g., light in the green wavelength band) into which a portion of the third light (e.g., light in the blue wavelength band) emitted from a light emitting element LE has been converted by the second light conversion layer QDL2 and may absorb or block the third light (e.g., light in the blue wavelength band), which has not been converted by the second light conversion layer QDL2. Accordingly, the second subpixel SPX2 may output the second light (e.g., light in the green wavelength band).

A third color filter CF3 disposed in the third subpixel SPX3 may transmit third light (e.g., light in the blue wavelength band). Therefore, the third color filter CF3 may transmit the third light (e.g., light in the blue wavelength band) that passes through the light transmission layer TPL after being emitted from a light emitting element LE. Accordingly, the third subpixel SPX3 may emit the third light (e.g., light in the blue wavelength band).

The first color filter CF1, the second color filter CF2, and the third color filter CF3 overlapping each other in the third direction DR3 may overlap the light blocking layer BM in the third direction DR3.

A sixth organic layer 214 for planarization may be disposed on the color filters CF1 through CF3.

The fifth organic layer 213 and the sixth organic layer 214 may be made of acryl resin, epoxy resin, phenolic resin, polyamide resin, and/or polyimide resin.

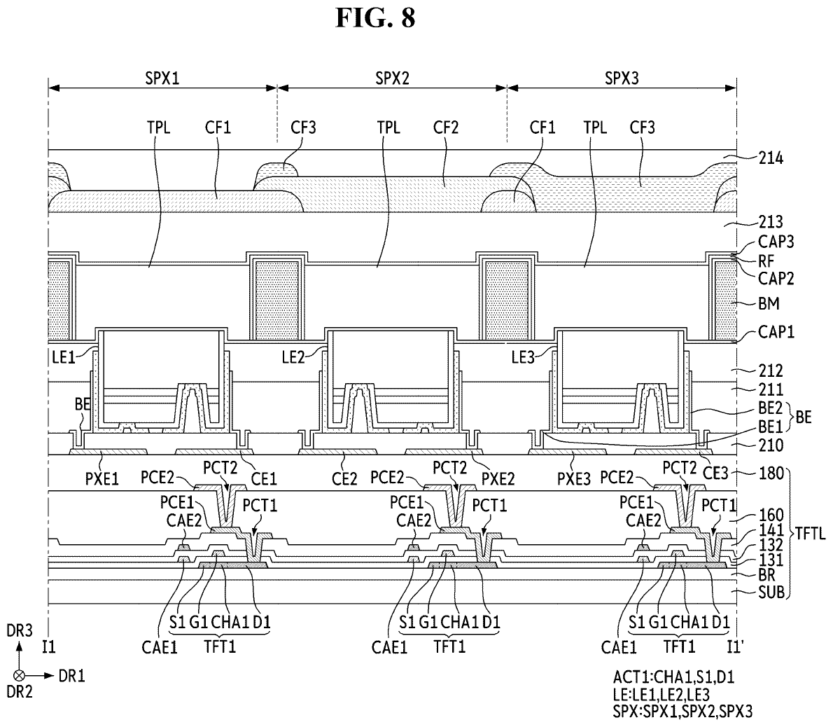

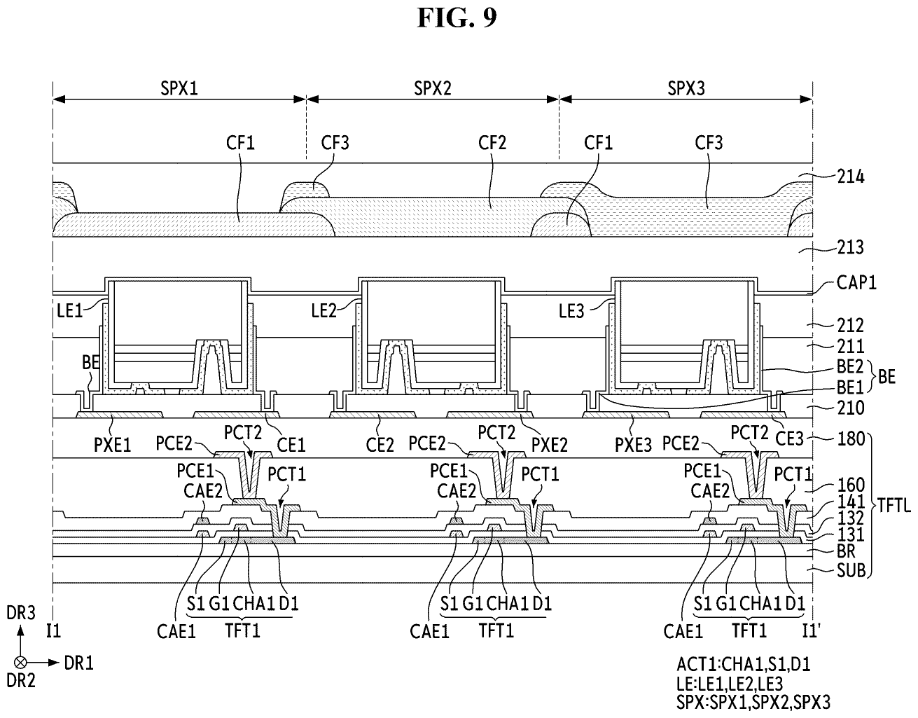

FIG. 8 is a cross-sectional view illustrating an example of a cross section of a display panel corresponding to the line I1-I1′ of FIG. 5. FIG. 9 is a cross-sectional view illustrating an example of a cross section of a display panel corresponding to the line I1-I1′ of FIG. 5. Compared with FIG. 6, FIGS. 8 and 9 show embodiments of a display panel 100 that does not include light conversion layers QDL1 and QDL2. In addition, FIGS. 8 and 9 show different embodiments in relation to a light blocking layer BM and a light transmission layer TPL.

Referring to FIGS. 8 and 9, subpixels SPX may include light emitting elements LE that emit light corresponding to their respective emission colors. For example, a first subpixel SPX1 may include at least one first light emitting element LE1 that emits first light (e.g., red light), a second subpixel SPX2 may include at least one second light emitting element LE2 that emits second light (e.g., green light), and a third subpixel SPX3 may include at least one third light emitting element LE3 that emits third light (e.g., blue light).

When the subpixels SPX include light emitting elements LE that emit light corresponding to their respective emission colors, the light emitted from the light emitting elements LE can be utilized more efficiently. For example, a decrease in the light efficiency of the subpixels SPX due to light conversion can be reduced or prevented. In addition, the color purity of light emitted from the subpixels SPX can be increased, and the color gamut of the subpixels SPX can be increased.

In one or more embodiments, each of the subpixels SPX may include a light transmission layer TPL. For example, as illustrated in FIG. 8, light transmission layers TPL of the subpixels SPX and a light blocking layer BM surrounding the light transmission layers TPL may be disposed on a first capping layer CAP1.

The light blocking layer BM may be disposed between and/or around emission areas of the subpixels SPX. The light blocking layer BM may surround the light transmission layers TPL of the subpixels SPX.

The light blocking layer BM may be a single layer or a multilayer. For example, the light blocking layer BM may be a single layer or, as in the embodiment of FIG. 6, may be a multilayer including a first light blocking layer BM1 and a second light blocking layer BM2.

The light blocking layer BM may include vertical side surfaces or, as in the embodiment of FIG. 6, may include inclined side surfaces. The shape, height, and/or structure of the light blocking layer BM may vary according to embodiments.

In one or more embodiments, the display panel 100 may further include a second capping layer CAP2 and a reflective layer RF disposed on the light blocking layer BM. For example, the second capping layer CAP2 and the reflective layer RF may be sequentially disposed on the light blocking layer BM.

The second capping layer CAP2 may cover the light blocking layer BM. For example, the second capping layer CAP2 may cover the side and upper surfaces of the light blocking layer BM. The second capping layer CAP2 may be disposed only on the light blocking layer BM or, as in the embodiment of FIG. 6, may be disposed in the entire display area DA.

The reflective layer RF may cover at least the side surfaces of the light blocking layer BM. For example, the reflective layer RF may cover the side and upper surfaces of the light blocking layer BM. The reflective layer RF may increase the amount of light emitted from the subpixels SPX and improve the light efficiency of the subpixels SPX.

A light transmission layer TPL may be disposed in the emission area of each subpixel SPX surrounded by the light blocking layer BM and the reflective layer RF. The light transmission layer TPL may be covered with a third capping layer CAP3.

The light transmission layers TPL may be optically transparent and may transmit light emitted from the light emitting elements LE of the subpixels SPX. For example, the light transmission layers TPL may transmit the first light, the second light, and the third light emitted from the first light emitting element LE1, the second light emitting element LE2, and the third light emitting element LE3.

In one or more embodiments, the light transmission layers TPL may include a light scatterer (or a light diffuser) such as titanium dioxide (TiO₂) and/or silicon dioxide (SiO₂). For example, the light transmission layers TPL may include a base resin including a light transmitting material and light scatterers dispersed in the base resin. Accordingly, the light output efficiency of the subpixels SPX can be increased.

The third capping layer CAP3 may be disposed on the light transmission layers TPL. In one or more embodiments, the third capping layer CAP3 may be formed in the entire display area DA to entirely cover the light transmission layers TPL and the light blocking layer BM. For example, the third capping layer CAP3 may be disposed on the light transmission layers TPL and the reflective layer RF. Alternatively, when the display panel 100 does not include the reflective layer RF, the third capping layer CAP3 may be disposed on the light transmission layers TPL and the second capping layer CAP2.

At least one overcoat layer and a color filter layer may be disposed on the third capping layer CAP3. For example, a fifth organic layer 213, color filters CF1 through CF3, and a sixth organic layer 214 may be disposed on the third capping layer CAP3.

In one or more embodiments, the subpixels SPX may not include the light transmission layers TPL. For example, as illustrated in FIG. 9, the display panel 100 may not include the light blocking layer BM, the second capping layer CAP2, the reflective layer RF, the light transmission layers TPL and the third capping layer CAP3 of FIG. 8, and the fifth organic layer 213, the color filters CF1 through CF3 and the sixth organic layer 214 may be disposed on the first capping layer CAP1 covering the light emitting elements LE.

In one or more embodiments, even though the subpixels SPX do not include the light transmission layers TPL and/or the light conversion layers QDL1 and QDL2, the display panel 100 may include the light blocking layer BM. For example, the display panel 100 may include the light blocking layer BM, the second capping layer CAP2 and the reflective layer RF of FIG. 8 and may not include the light transmission layers TPL and the third capping layer CAP3. In this case, the fifth organic layer 213, the color filters CF1 through CF3, and the sixth organic layer 214 may be disposed on the first capping layer CAP1 and the reflective layer RF. When the display panel 100 does not include the reflective layer RF, the fifth organic layer 213, etc. may be directly disposed on the second capping layer CAP2.

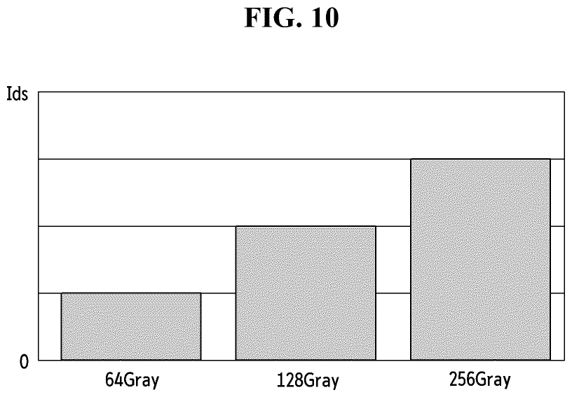

FIG. 10 is a graph illustrating a driving current of a subpixel for each gray level according to one or more embodiments.

Referring to FIG. 10, the driving current Ids (e.g., FIG. 4) of a different magnitude may flow through the subpixel SPX according to the gray level to be expressed in the subpixel SPX during each emission period (e.g., an emission period corresponding to an on-duty ratio of each frame or each horizontal period). For example, the data driver 252 of FIG. 3 may output a data voltage, which corresponds to a gray level to be expressed in each subpixel SPX, in response to the video data DATA of each frame. Accordingly, the driving current Ids of a magnitude corresponding to the data voltage may flow during an emission period of the subpixel SPX (e.g., an on-duty period during which an emission control signal of a gate-on voltage is supplied to the subpixel SPX in among each frame or each horizontal period of the subpixel SPX or the pixel PX).

In one or more embodiments, the display device 10 may control the luminance of the subpixel SPX using a pulse-amplitude modulation (PAM) method. For example, an on-duty ratio of the subpixel SPX may be maintained constant by supplying an emission control signal having a uniform pulse width to the subpixel SPX regardless of the gray level to be expressed in the subpixel SPX. In addition, the luminance of the subpixel SPX may be controlled by changing and/or controlling a data voltage and the magnitude of the driving current Ids corresponding to the data voltage according to the gray level to be expressed in the subpixel SPX.

For example, the driving current Ids of the subpixel SPX corresponding to a gray level of 128 may be greater than the driving current Ids of the subpixel SPX corresponding to a gray level of 64 and may be smaller than the driving current Ids of the subpixel SPX corresponding to a gray level of 256. In the graph of FIG. 10, the driving current Ids of the subpixel SPX increases linearly with respect to the gray level, but the present disclosure is not limited thereto. For example, the magnitude of the driving current Ids for each gray level may be appropriately adjusted according to the emission characteristics of a light emitting element LE and a subpixel SPX including the light emitting element LE.

In one or more embodiments, the data driver 252 may supply a uniform data voltage to the subpixels SPX in response to each gray level of the video data DATA. For example, the data driver 252 may supply a uniform data voltage to the first subpixel SPX1, the second subpixel SPX2, and the third subpixel SPX3 in response to each gray level. Accordingly, the driving current Ids flowing through the subpixels SPX corresponding to each gray level may be substantially the same.

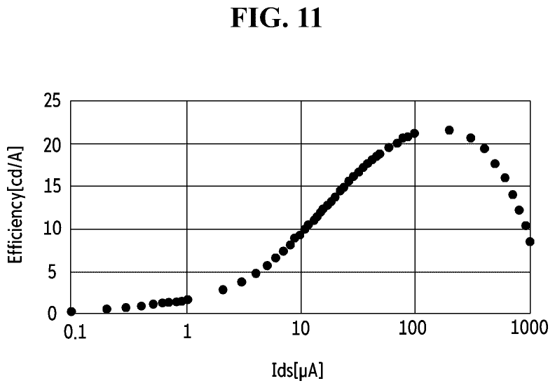

FIG. 11 is a graph showing efficiency of a first light emitting element according to a driving current. For example, FIG. 11 shows a change in efficiency according to the driving current Ids of the first light emitting element LE1 (e.g., red micro LED) emitting the first light.

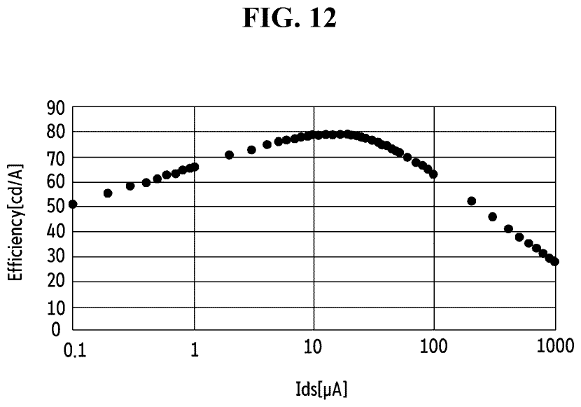

FIG. 12 is a graph showing efficiency of a second light emitting element according to a driving current. For example, FIG. 12 shows a change in efficiency according to the driving current Ids of the second light emitting element LE2 (e.g., green micro LED) emitting the second light.

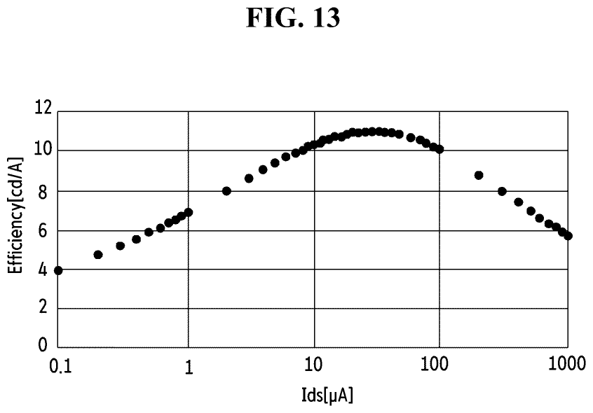

FIG. 13 is a graph showing efficiency of a third light emitting element according to a driving current. For example, FIG. 13 shows a change in efficiency according to the driving current Ids of the third light emitting element LE3 (e.g., blue micro LED) emitting the third light.

Referring to FIGS. 11-13, the first light emitting element LE1, the second light emitting element LE2, and the third light emitting element LE3 may show different efficiencies depending on the driving currents Ids. For example, even if the first light emitting element LE1, the second light emitting element LE2, and the third light emitting element LE3 have a same size and/or shape (e.g., a rectangular shape with horizontal and vertical lengths of 18 μm and 36 μm, respectively, when viewed from a plane), the first light emitting element LE1, the second light emitting element LE2, and the third light emitting element LE3 may show different efficiencies from each other with respect to the consumed driving current Ids.

In addition, the size or range of the driving current Ids at which the first light emitting element LE1, the second light emitting element LE2, and the third light emitting element LE3 show the highest efficiency may be different from each other. For example, the first light emitting element LE1 may exhibit maximum efficiency in a current range of approximately 100 μA to 300 μA. On the other hand, the second light emitting element LE2 may exhibit maximum efficiency in a current range of approximately 10 μA to 20 μA, and the third light emitting element LE3 may exhibit maximum efficiency in a current range of approximately 20 μA to 40 μA.

Accordingly, when the first light emitting element LE1, the second light emitting element LE2, and the third light emitting element LE3 are driven with a uniform driving current Ids according to each gray level, it may be difficult for at least one of the first light emitting element LE1, the second light emitting element LE2, or the third light emitting element LE3 to be driven in the optimal driving range. Accordingly, the consumption efficiency (or power efficiency) of the light emitting elements LE may decrease.

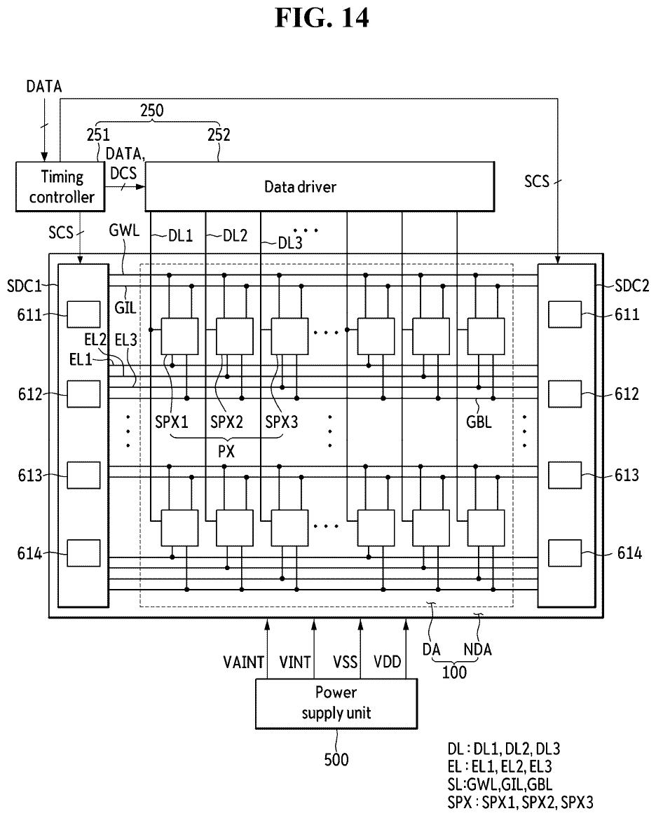

FIG. 14 is a block diagram of a display device according to one or more embodiments. The embodiment of FIG. 14 is different from the embodiment of FIG. 3 in that a first subpixel SPX1, a second subpixel SPX2, and a third subpixel SPX3 of each pixel PX are connected to different emission control lines EL.

Referring to FIG. 14, a display panel 100 may include a plurality of emission control lines EL disposed on each horizontal line (e.g., each row) of a display area DA and connected to different subpixels SPX. For example, on each horizontal line of the display area DA, a first emission control line EL1 connected to first subpixels SPX1 of the horizontal line, a second emission control line EL2 connected to second subpixels SPX2 of the horizontal line, and a third emission control line EL3 connected to third subpixels SPX3 of the horizontal line may be disposed.

In one or more embodiments, the first subpixel SPX1, the second subpixel SPX2, and the third subpixel SPX3 of each pixel PX may be disposed on the same horizontal line in the display area DA where the pixel PX is disposed and may be connected to different emission control lines EL. Because the first subpixel SPX1, the second subpixel SPX2, and the third subpixel SPX3 of each pixel PX are connected to different emission control lines EL, emission control signals supplied to the first subpixel SPX1, the second subpixel SPX2, and the third subpixel SPX3 can be individually and/or independently controlled and/or changed. Accordingly, emission periods or on-duty ratios of the first subpixel SPX1, the second subpixel SPX2, and the third subpixel SPX3 included in each pixel PX can be individually and/or independently controlled and/or modified.

The emission control signal output unit 614 may output emission control signals having pulse widths different from each other to at least two emission control lines EL from among the first emission control line EL1, the second emission control line EL2, and the third emission control line EL3. For example, the emission control signal output unit 614 may output a first emission control signal of a first width, a second emission control signal of a second width, and a third emission control signal of a third width to the first emission control line EL1, the second emission control line EL2, and the third emission control line EL3, respectively. The first width, second width, and third width may correspond to pulse widths of gate-on voltages of the first emission control signal, the second emission control signal, and the third emission control signal, respectively. In one or more embodiments, the first width, second width, and third width may correspond to a first on-duty ratio, a second on-duty ratio, and a third on-duty ratio, respectively.

In one or more embodiments, the emission control signal output unit 614 may include stage circuits that output a first emission control signal of a first width to each of the first emission control lines EL1 of the display area DA, stage circuits that output a second emission control signal of a second width to each of the second emission control lines EL2 of the display area DA, and stage circuits that output a third emission control signal of a third width to each of the third emission control lines EL3 of the display area DA. Alternatively, the emission control signal output unit 614 may differentiate pulse widths of the emission control signals outputted to the first emission control lines EL1, the second emission control lines EL2, and/or the third second emission control lines EL3 by including a pulse width modulator for changing and/or adjusting the pulse width of at least one of the first emission control signal, the second emission control signal, or the third emission control signal to output, or by other methods.

The first subpixel SPX1, the second subpixel SPX2, and the third subpixel SPX3 may emit light for different times and/or different durations in response to their respective emission control signals. For example, the first subpixel SPX1, the second subpixel SPX2, and the third subpixel SPX3 may respond to the first emission control signal, the second emission control signal, and the third emission control signal, respectively, and emit light during different times. On-duty ratios of the first subpixel SPX1, the second subpixel SPX2, and the third subpixel SPX3 may be different.

In one or more embodiments, in generating or outputting a data voltage corresponding to each gray level of video data DATA, the data driver 252 may output data voltages of different sizes to the to the first data line DL1, the second data line DL2, and the third data line DL3. Accordingly, the first subpixel SPX1, the second subpixel SPX2, and the third subpixel SPX3 of each pixel PX may be driven with driving currents Ids of different values (e.g., different sizes and/or ranges). For example, the data driver 252 may change, control, and/or differentiate the data voltage supplied to the first data line DL1, the second data line DL2, and the third data line DL3 so that the first light emitting element LE1, the second light emitting element LE2, and the third light emitting element LE3 are driven by the driving current Ids showing the optimal consumption efficiency (or power efficiency).

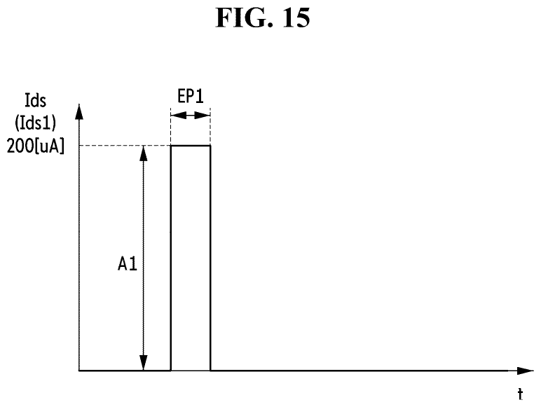

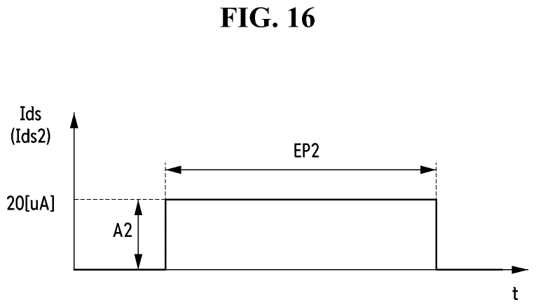

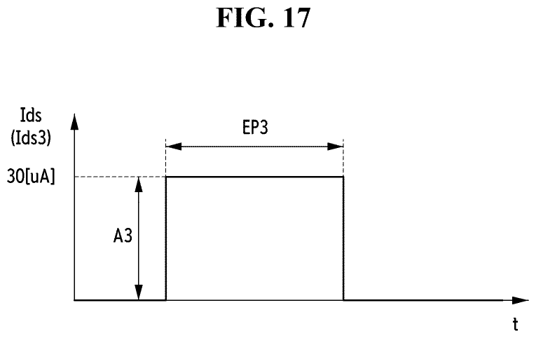

FIG. 15 is a graph showing a driving current and an emission period of a first light emitting element according to one or more embodiments. FIG. 16 is a graph showing a driving current and an emission period of a second light emitting element according to one or more embodiments. FIG. 17 is a graph showing a driving current and an emission period of a third light emitting element according to one or more embodiments. For example, FIGS. 15-17 show schematic waveforms of a first driving current Ids1, a second driving current Ids2, and a third driving current Ids3 flowing respectively through the first light emitting element LE1 (e.g., see FIG. 8), the second light emitting element LE2 (e.g., see FIG. 8), and the third light emitting element LE3 (e.g., see FIG. 8) corresponding to the highest gray level (e.g., gray level of 256).

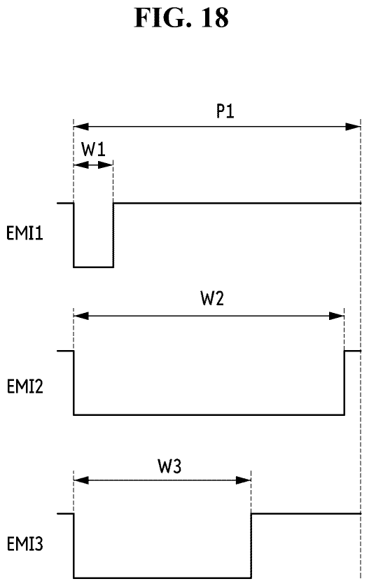

FIG. 18 is a waveform diagram of emission control signals according to one or more embodiments. For example, FIG. 18 shows a schematic waveforms of a first emission control signal EMI1, a second emission control signal EMI2, and a third emission control signal EMI3 supplied to the first emission control line EL1, the second emission control line EL2, and the third emission control line EL3, respectively.

Referring to FIGS. 15-18 in conjunction with FIGS. 8-14, the subpixels SPX may be driven by different driving currents Ids. For example, the first driving current Ids1 optimized for the efficiency of the first light emitting element LE1 (e.g., see FIG. 8) may flow through the first light emitting element LE1 of the first subpixel SPX1. The second driving current Ids2 optimized for the efficiency of the second light emitting element LE2 (e.g., see FIG. 8) may flow through the second light emitting element LE2 of the second subpixel SPX2. The third driving current Ids3 optimized for the efficiency of the third light emitting element LE3 (e.g., see FIG. 8) may flow through the third light emitting element LE3 of the third subpixel SPX3.

In one or more embodiments, the data driver 252 may output a data voltage adjusted so that a driving current Ids optimized for each light emitting element LE flows in each subpixel SPX. For example, the data driver 252 may adjust data voltages outputted to the first data line DL1, the second data line DL2, and the third data line DL34, so that the driving currents Ids optimized for the first light emitting element LE1, the second light emitting element LE2, and the third light emitting element LE3 flow in the first subpixel SPX1, the second subpixel SPX2, and the third subpixel SPX3, respectively. For example, the data driver 252 may output the first driving current Ids1, the second driving current Ids2, and the third driving current Ids3 optimized for luminous efficiency of the first light emitting element LE1, the second light emitting element LE2, and the third light emitting element LE3 to the first data line DL1, the second data line DL2, and the third data line DL3, respectively.

In one or more embodiments, when each of the subpixels SPX is required to be driven at the highest gray level, the data driver 252 may output a first data voltage, a second data voltage, and a third data voltage to the first data line DL1, the second data line DL2, and the third data line DL3, respectively. Accordingly, the first driving current Ids1, the second driving current Ids2, and the third driving current Ids3 corresponding to the first data voltage, the second data voltage, and the third data voltage may flow in the first subpixel SPX1, the second subpixel SPX2, and the third subpixel SPX3, respectively.

In one or more embodiments, the driving current Ids of the first subpixel SPX1, the second subpixel SPX2, and the third subpixel SPX3 based on the highest gray level (e.g., gray level of 256) of the video data DATA may be changed and/or optimized. For example, when the first data voltage corresponding to the highest gray level is supplied to the first subpixel SPX1, the first light emitting element LE1 is supplied with the first driving current Ids1 in the range of approximately 100 μA to 300 μA, for example, 200 μA. In the same method, when the second data voltage corresponding to the highest gray level is supplied to the second subpixel SPX2, the second light emitting element LE2 is supplied with the second driving current Ids2 in the range of approximately 10 μA to 20 μA, for example, 20 μA. In addition, when the third data voltage corresponding to the highest gray level is supplied to the third subpixel SPX3, the third light emitting element LE3 is supplied with the third driving current Ids3 in the range of approximately 20 μA to 40 μA, for example, 30 μA.

In addition, the data driver 252 may appropriately control, change, and/or optimize the data voltages of the rest of the gray levels in accordance with the driving current Ids corresponding to the highest gray level. For example, when the data voltage of the highest gray level increases so that the driving current Ids corresponding to the highest gray level increases, the data driver 252 may increase data voltage of each of the rest of the gray levels appropriately so that the driving current Ids for each of the remaining gray levels can be increased.

In one or more embodiments, the emission periods or on-duty ratios of the subpixels SPX may be appropriately adjusted, changed, and/or differentiated in response to the deviation of the driving current flowing in the light emitting elements LE of the subpixels SPX. For example, as a larger driving current Ids flows through the subpixel SPX in response to each gray level, the emission period or on-duty ratio during which the driving current Ids flows through the corresponding subpixel SPX may decrease. Accordingly, it is possible to prevent or compensate for the deviation of the light emission luminance (or accumulated light emission amount) due to the deviation of the driving current in the subpixels SPX and cause the subpixels SPX to emit light with uniform luminance in response to each gray level.

For example, corresponding to the same gray level (e.g., the maximum grey level), the first driving current Ids1 having a first amplitude A1, the second driving current Ids2 having a second amplitude A2, and the third driving current Ids3 having a third amplitude A3 may flow in the first subpixel SPX1, the second subpixel SPX2, and the third subpixel SPX3, respectively. In one or more embodiments, the first amplitude A1 may be greater than the second amplitude A2 and the third amplitude A3. In this case, the on-duty ratio of the first subpixel SPX1 may be smaller than the on-duty ratio of each of the second subpixel SPX2 and the third subpixel SPX3. For example, a first emission period EP1 of the first subpixel SPX1 may be set to be shorter than a second emission period EP2 of the second subpixel SPX2 and a third emission period EP3 of the third subpixel SPX3. In one or more embodiments, the second amplitude A2 may be smaller than the first amplitude A1 and the third amplitude A3. In this case, the on-duty ratio of the second subpixel SPX2 may be greater than the on-duty ratio of each of the first subpixel SPX1 and the third subpixel SPX3. For example, the second emission period EP2 of the second subpixel SPX2 may longer than the first emission period EP1 of the first subpixel SPX1 and the third emission period EP3 of the third subpixel SPX3.

In one or more embodiments, the first emission period EP1 may be a period in which the first driving current Ids1 flows in the first light emitting element LE1 during one emission cycle (for example, one cycle P1 of the first emission control signal EMI1). Similarly, the second emission period EP2 may be a period in which the second driving current Ids2 flows in the second light emitting element LE2 during one emission cycle (for example, one cycle P1 of the second emission control signal EMI2), and the third emission period EP3 may be a period in which the third driving current Ids3 flows in the third light emitting element LE3 during one emission cycle (for example, one cycle P1 of the third emission control signal EMI3).

In one or more embodiments, the emission period of each of the subpixels SPX may be controlled by the emission control signal supplied to each of the subpixels SPX. For example, the emission control signal output unit 614 may supply emission control signals having different pulse widths from each other to the subpixels SPX so that deviations of emission luminance according to deviations of the driving current of the subpixels SPX can be prevented and/or compensated.

In one or more embodiments, the emission control signal output unit 614 (or the timing controller 251 outputting the scan timing control signal SCS to the emission control signal output unit 614) may adjust or differentiate the emission periods of the subpixels SPX with respect to the subpixel SPX in which the lowest driving current Ids flows from among the subpixels SPX. For example, the emission control signal output unit 614 may control the second emission period EP2 of the second subpixel SPX2 to be the longest or maximum. For example, the emission control signal output unit 614 may output the second emission control signal EMI2 having the on-duty ratio of approximately 97% (for example, the second emission control signal EMI2 having a pulse width corresponding to 97% of one cycle P1) to the second emission control line EL2, thereby controlling the second emission period EP2 of the second subpixel SPX2 to be the longest or maximum.

In one or more embodiments, the emission control signal output unit 614 may control the first emission period EP1 and the second emission period EP2 to be different in response to the ratio (or difference value) of the first driving current Ids1 and the second driving current Ids2. For example, when the first driving current Ids1 is N times the second driving current Ids2, the emission control signal output unit 614 may output the first emission control signal EMI1 having the on-duty ratio corresponding to approximately 1/N times of the on-duty ratio of the second emission control signal EMI2 to the first emission control line EL1, thereby controlling the first emission control period EP1 to be 1/N times of the second emission control period EP2. For example, when the first driving current Ids1 is ten times the second driving current Ids2, the emission control signal output unit 614 may control the first emission period EP1 to be 1/10 times the second emission period EP2 (for example, the period corresponding to the on-duty ratio of approximately 9.7%).

In the same method, the emission control signal output unit 614 may set the second emission period EP2 and the third emission period EP3 to be different in response to the ratio (or difference value) of the second driving current Ids2 and the third driving current Ids3. For example, when the third driving current Ids3 is K times the second driving current Ids2, the emission control signal output unit 614 may output the third emission control signal EMI3 having the on-duty ratio corresponding to approximately 1/K times of the on-duty ratio of the second emission control signal EMI2 to the third emission control line EL3, thereby controlling the third emission period EP3 to be 1/K times the second emission period EP2. For example, when the third driving current Ids3 is 1.5 times the second driving current Ids2, the emission control signal output unit 614 may control the third emission period EP3 to be 1/1.5 times of the second emission period EP2 (for example, the period corresponding to the on-duty ratio of approximately 65%).

The light emission luminance or accumulated light emission amount of the light emitting element LE corresponding to each data voltage may change depending on the on-duty ratio and the driving current Ids flowing in each of the light emitting element LE during each of the emission cycle (for example, one horizontal period or one frame period). For example, the light emission luminance or accumulated light emission amount of the light emitting element LE during one emission cycle may correspond to a value obtained by multiplying the driving current Ids flowing through the light emitting element LE during the corresponding emission cycle by the on-duty ratio.

In one or more embodiments, the emission control signal output unit 614 may control or differentiate the emission periods of the subpixels SPX so that the product of the driving current Ids corresponding to each gray level and the on-duty ratio is maintained at a constant value. Accordingly, the light emitting elements LE and/or the subpixels SPX including thereof may emit light with uniform luminance in response to each gray level during each emission period.

In one or more embodiments, the emission control signal output unit 614 may supply the first emission control signal EMI1 of a first width W1 to the first emission control line EL1. The first width W1 may be a pulse width of a section in which the first emission control signal EMI1 has a gate-on voltage (for example, the low-level voltage at which the fifth and sixth transistors ST5 and ST6 of FIG. 4 can be turned on) and may be a width corresponding to the first on-duty ratio (e.g., 9.7%) among one cycle P1 of the first emission control signal EMI1. The first subpixel SPX1 to which the first emission control signal EMI1 of the first width W1 is supplied may emit light by the first emission control signal EMI1 of the gate-on voltage during the first emission period EP1 corresponding to the first width W1.

Similarly, the emission control signal output unit 614 may supply the second emission control signal EMI2 of a second width W2 to the second emission control line EL2. The second width W2 may be a pulse width of a section in which the second emission control signal EMI2 has a gate-on voltage and may be a width corresponding to the second on-duty ratio (e.g., 97%) among one cycle P1 of the second emission control signal EMI2. The second subpixel SPX2 to which the second emission control signal EMI2 of the second width W2 is supplied may emit light by the second emission control signal EMI2 of the gate-on voltage during the second emission period EP2 corresponding to the second width W2.

In addition, the emission control signal output unit 614 may supply the third emission control signal EMI3 of a third width W3 to the third emission control line EL3. The third width W3 may be a pulse width of a section in which the third emission control signal EMI3 has a gate-on voltage and may be a width corresponding to the third on-duty ratio (e.g., 65%) among one cycle P1 of the third emission control signal EMI3. The third subpixel SPX3 to which the third emission control signal EMI3 of the third width W3 is supplied may emit light by the third emission control signal EMI3 of the gate-on voltage during the third emission period EP3 corresponding to the third width W3.

However, the present disclosure is not limited thereto. For example, the emission period of each of the subpixels SPX may be appropriately adjusted or changed in consideration with the emission characteristics of the subpixels SPX.

Moreover, although an embodiment in which the gate voltages of the first to third emission control signals EMI1 to EMI3 are low-level voltages that can turn-on the fifth and sixth transistors ST5 and ST6 of FIG. 4 is illustrated in FIG. 18, the present disclosure is not limited thereto. For example, the gate-on voltage and the gate-off voltage of each of the first to third emission control signals EMI1 to EMI3 may be changed depending on the type of the switching elements controlled by the first to third emission control signals EMI1 to EMI3. For example, when the fifth and sixth transistors ST5 and ST6 of FIG. 4 are changed to N-type transistors, the gate-on voltage of each of the first to third emission control signals EMI1 to EMI3 may be high-level voltage, and the gate-off voltage may be low-level voltage.

The pixel circuits of the first subpixel SPX1, the second subpixel SPX2, and the third subpixel SPX3 (for example, the pixel circuit including the driving transistor DT, the switch elements and the capacitor C1 of FIG. 4) may respectively generate the driving current Ids in response to each of the data voltages. For example, the pixel circuit of the first subpixel SPX1 may generate the first driving current Ids1 corresponding to the first data voltage input through the first data line DL1. The pixel circuit of the second subpixel SPX2 may generate the second driving current Ids2 corresponding to the second data voltage input through the second data line DL2. The pixel circuit of the third subpixel SPX3 may generate the third driving current Ids3 corresponding to the third data voltage input through the third data line DL3.

The pixel circuits of the first subpixel SPX1, the second subpixel SPX2, and the third subpixel SPX3 may respectively supply the driving currents Ids to the light emitting elements LE during each of the emission periods corresponding to the emission control signals, respectively. For example, the pixel circuit of the first subpixel SPX1 may supply the first driving current Ids1 to the first light emitting element LE1 during the first emission period EP1 corresponding to the first width W1 in response to the first emission control signal EMI1 of the first width W1 input through the first emission control line EL1. The pixel circuit of the second subpixel SPX2 may supply the second driving current Ids2 to the second light emitting element LE2 during the second emission period EP2 corresponding to the second width W2 in response to the second emission control signal EMI2 of the second width W2 input through the second emission control line EL2. The pixel circuit of the third subpixel SPX3 may supply the third driving current Ids3 to the third light emitting element LE3 during the third emission period EP3 corresponding to the third width W3 in response to the third emission control signal EMI3 of the third width W3 input through the third emission control line EL3.

A method of driving the display device 10 according to the above-described embodiments may include driving the first subpixel SPX1, the second subpixel SPX2, and the third subpixel SPX3 with driving currents of different magnitudes in response to each grey scale of the video data DATA. In one or more embodiments, driving the first to third subpixels SPX1 to SPX3 with driving currents of different magnitude may further include setting the driving currents Ids of the first to third subpixels as the first to third driving currents Ids1 to Ids3, respectively, in accordance with the efficiency of each of the first to third subpixels SPX1 to SPX3, and supplying the data voltages of magnitudes corresponding to the first to third driving currents Ids1 to Ids3 to the first to third subpixels SPX1 to SPX3, respectively. Although the method of adjusting and/or differentiating the driving current Ids flowing in the subpixels SPX by adjusting the data voltages supplied to the subpixels SPX are discussed in embodiments of the present disclosure, the method of adjusting and/or differentiating the driving current Ids flowing in the subpixels SPX is not limited thereto.

In addition, the method of driving the display device 10 according to the above-described embodiments may further include controlling the light emission time and the on-duty ratio of the first subpixel SPX1, the second subpixel SPX2, and the third subpixel SPX3 to be different according to the driving current Ids of the first subpixel SPX1, the second subpixel SPX2, and the third subpixel SPX3. In one or more embodiments, controlling the light emission time and the on-duty ratio of the first subpixel SPX1, the second subpixel SPX2, and the third subpixel SPX3 to be different may include setting the emission periods (for example, the first emission period EP1, the second emission period EP2, and the third emission period EP3) of the first subpixel SPX1, the second subpixel SPX2, and the third subpixel SPX3 so that the light emission time or the on-duty ratio decreases as the driving current Ids corresponding to each grey scale of the video data DATA increases, and supplying the emission control signals of pulse widths corresponding to each of the emission periods of the first subpixel SPX1, the second subpixel SPX2, and the third subpixel SPX3 (for example, the first emission control signal EMI1, the second emission control signal EMI2, and the third emission control signal EMI3) to the first subpixel SPX1, the second subpixel SPX2, and the third subpixel SPX3, respectively. Although the method of adjusting and/or differentiating the light emission time or on-duty ratio of the subpixels SPX by adjusting the pulse widths of emission control signals supplied to the subpixels SPX are discussed in embodiments of the present disclosure, the method of adjusting and/or differentiating the emission time or on-duty ratio of the subpixels SPX is not limited thereto.

As described above, according to the display device 10 and the method of driving the same according to the embodiments, the driving currents Ids flowing in the subpixels SPX may be adjusted or optimized in accordance with the efficiency of the light emitting elements LE of each of the subpixels SPX. In addition, by adjusting the emission period or the on-duty ratio of each of the subpixels SPX in response to each of the adjusted driving currents Ids, deviations of luminance according to deviations of the driving currents of the subpixels SPX may be prevented and/or compensated.

According to one or more embodiments, luminance of the subpixels SPX may be maintained to be uniform while concurrently (e.g., simultaneously) improving consumption efficiency (or power efficiency) of the light emitting elements LE. Accordingly, the consumption power of the display device 10 may be improved and display quality may be secured.

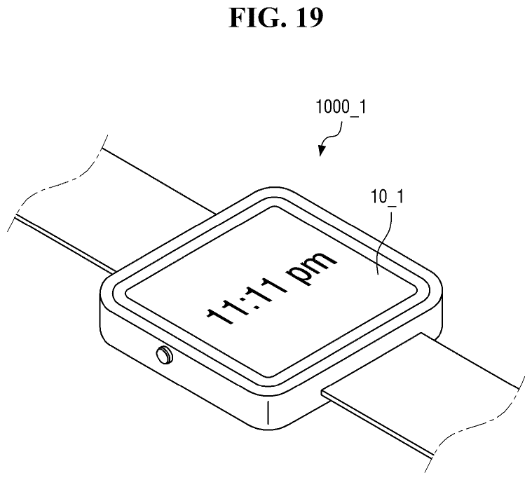

FIG. 19 is an example view of a smart watch including a display device according to one or more embodiments. Referring to FIG. 19, a display device 10_1 according to one or more embodiments may be applied to a smart watch 1000_1 which is one of smart devices.

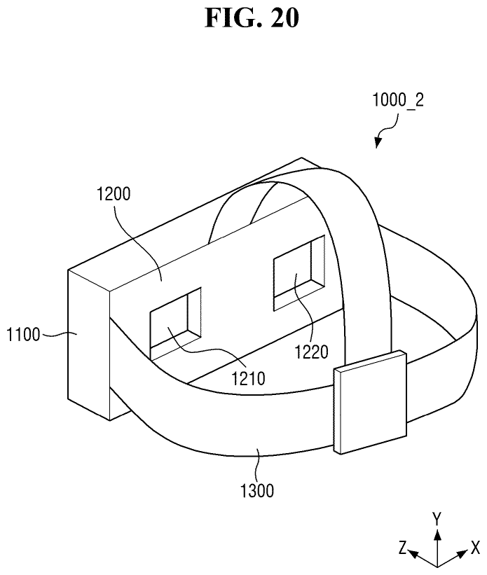

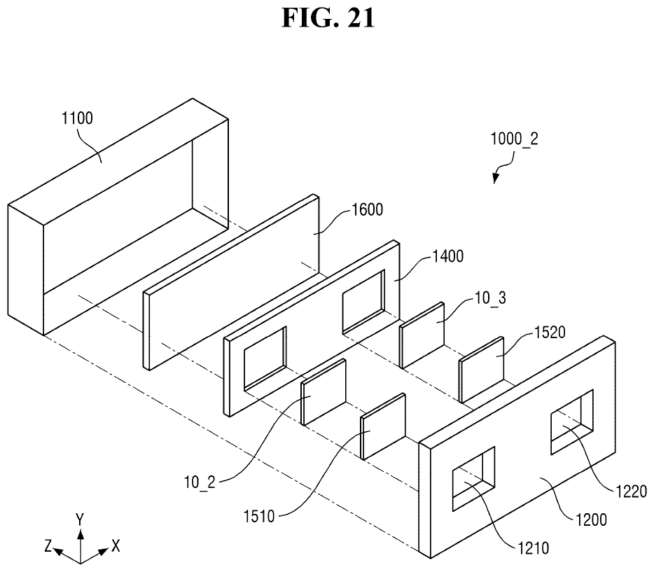

FIGS. 20 and 21 are example views of a virtual reality (VR) device including a display device according to one or more embodiments.

Referring to FIGS. 20 and 21, a head mounted display device 1000_2 according to one or more embodiments includes a first display device 10_2, a second display device 10_3, a display device housing 1100, a housing cover 1200, a first eyepiece 1210, a second eyepiece 1220, a head mounted band 1300, a middle frame 1400, a first optical member 1510, a second optical member 1520, and a control circuit board 1600.

first display device 10_2 provides an image to a user's left eye, and the second display device 10_3 provides an image to the user's right eye. Each of the first display device 10_2 and the second display device 10_3 is substantially the same as the display device 10 described with reference to FIGS. 1 and 2. Therefore, a description of the first display device 10_2 and the second display device 10_3 will be omitted.

The first optical member 1510 may be disposed between the first display device 10_2 and the first eyepiece 1210. The second optical member 1520 may be disposed between the second display device 10_3 and the second eyepiece 1220. Each of the first optical member 1510 and the second optical member 1520 may include at least one convex lens.

The middle frame 1400 may be disposed between the first display device 10_2 and the control circuit board 1600 and may be disposed between the second display device 10_3 and the control circuit board 1600. The middle frame 1400 supports and fixes the first display device 10_2, the second display device 10_3, and the control circuit board 1600.

The control circuit board 1600 may be disposed between the middle frame 1400 and the display device housing 1100. The control circuit board 1600 may be connected to the first display device 10_2 and the second display device 10_3 through a connector. The control circuit board 1600 may convert an image source received from the outside into video data DATA and transmit the video data DATA to the first display device 10_2 and the second display device 10_3 through the connector.

The control circuit board 1600 may transmit the video data DATA corresponding to a left image optimized for a user's left eye to the first display device 10_2 and transmit the video data DATA corresponding to a right image optimized for the user's right eye to the second display device 10_3. Alternatively, the control circuit board 1600 may transmit the same video data DATA to the first display device 10_2 and the second display device 10_3.

The display device housing 1100 houses the first display device 10_2, the second display device 10_3, the middle frame 1400, the first optical member 1510, the second optical member 1520, and the control circuit board 1600. The housing cover 1200 is placed to cover an open surface of the display device housing 1100. The housing cover 1200 may include the first eyepiece 1210 on which a user's left eye is placed and the second eyepiece 1220 on which the user's right eye is placed. Although the first eyepiece 1210 and the second eyepiece 1220 are disposed separately in FIGS. 20 and 21, the present disclosure is not limited thereto. The first eyepiece 1210 and the second eyepiece 1220 may also be combined into one.

The first eyepiece 1210 may be aligned with the first display device 10_2 and the first optical member 1510, and the second eyepiece 1220 may be aligned with the second display device 10_3 and the second optical member 1520. Therefore, a user can view an image of the first display device 10_2, which is enlarged as a virtual image by the first optical member 1510, through the first eyepiece 1210 and can view an image of the second display device 10_3, which is enlarged as a virtual image by the second optical member 1520, through the second eyepiece 1220.

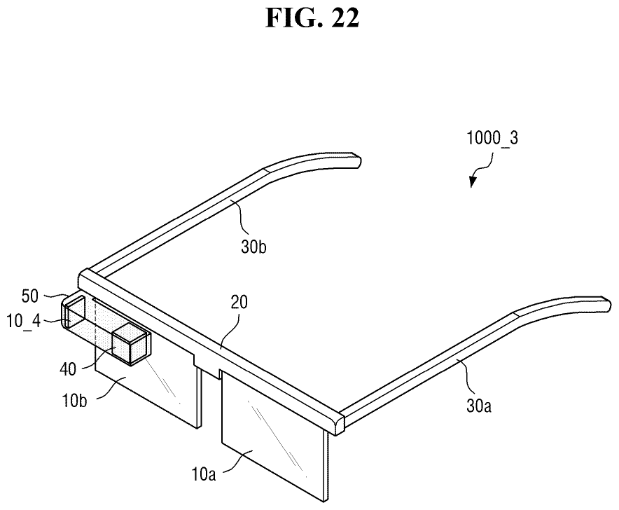

The head mounted band 1300 fixes the display device housing 1100 to a user's head so that the first eyepiece 1210 and the second eyepiece 1220 of the housing cover 1200 are kept placed on the user's left and right eyes, respectively. When the display device housing 1200 is implemented to be lightweight and small, the head mounted display device 1000_2 may include an eyeglass frame as illustrated in FIG. 22 instead of the head mounted band 1300.

In addition, the head mounted display device 1000_2 may further include a battery for supplying power, an external memory slot for accommodating an external memory, and an external connection port and a wireless communication module for receiving an image source. The external connection port may be a universe serial bus (USB) terminal, a display port, or a high-definition multimedia interface (HDMI) terminal, and the wireless communication module may be a 5G communication module, a 4G communication module, a Wi-Fi module, or a Bluetooth module.

FIG. 22 is an example view of a VR device including a display device according to one or more embodiments. FIG. 22 illustrates a VR device 1000_3 to which a display device 10_4 according to one or more embodiments has been applied.

Referring to FIG. 22, the VR device 1000_3 according to one or more embodiments may be a device in the form of glasses. The VR device 1000_3 according to the embodiment may include the display device 10_4, a left lens 10a, a right lens 10b, a support frame 20, eyeglass frame legs 30a and 30b, a reflective member 40, and a display device housing 50.

In FIG. 22, a case where the VR device 1000_3 is a glasses-type display device including the eyeglass frame legs 30a and 30b is illustrated as an example. That is, the VR device 1000_3 according to the embodiment is not limited to the one illustrated in FIG. 22 and can be applied in various forms to various other electronic devices.

The display device housing 50 may include the display device 10_4 and the reflective member 40. An image displayed on the display device 10_4 may be reflected by the reflective member 40 and provided to a user's right eye through the right lens 10b. Accordingly, the user may view a VR image displayed on the display device 10_4 through the right eye.

Although the display device housing 50 is disposed at a right end of the support frame 20 in FIG. 22, the present disclosure is not limited thereto. For example, the display device housing 50 may also be disposed at a left end of the support frame 20. In this case, an image displayed on the display device 10_4 may be reflected by the reflective member 40 and provided to the user's left eye through the left lens 10a. Accordingly, the user may view a VR image displayed on the display device 10_4 through the left eye. Alternatively, the display device housing 50 may be disposed at both the right end and the left end of the support frame 20. In this case, the user may view a VR image displayed on the display device 10_4 through both the left eye and the right eye.

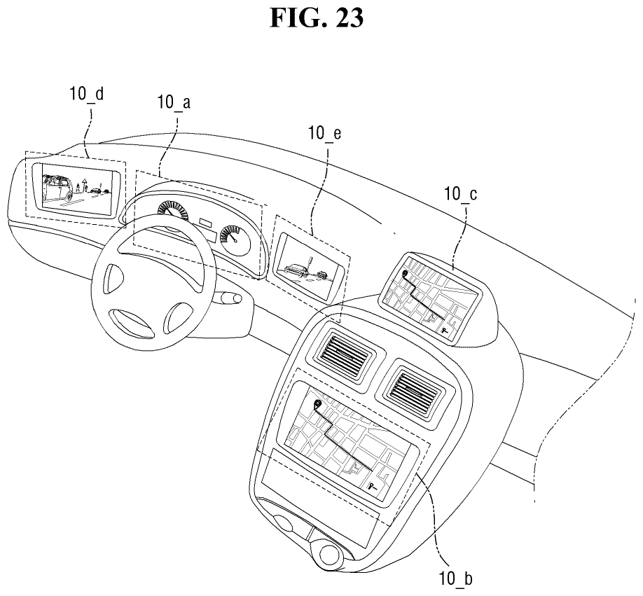

FIG. 23 is an example view illustrating a vehicle instrument cluster and center fascia including display devices according to one or more embodiments. FIG. 23 illustrates a vehicle to which display devices 10_a through 10_e according to one or more embodiments have been applied.

Referring to FIG. 23, the display devices 10_a through 10_c according to the embodiment may be applied to an instrument cluster of the vehicle, a center fascia of the vehicle, or a center information display (CID) disposed on a dashboard of the vehicle. In addition, the display devices 10_d and 10_e according to the embodiment may be applied to room mirror displays that replace side mirrors of the vehicle.

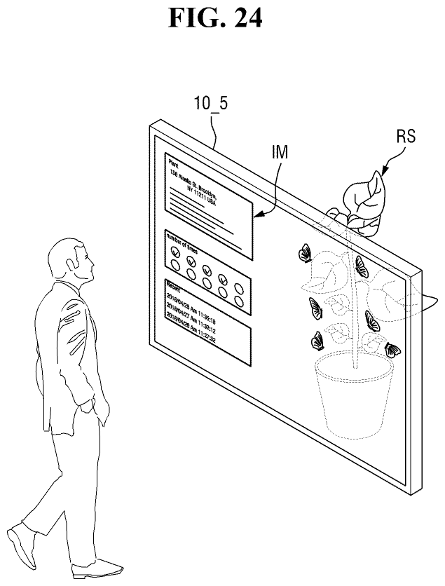

FIG. 24 is an example view of a transparent display device including a display device according to one or more embodiments.

Referring to FIG. 24, a display device 10_5 according to one or more embodiments may be applied to a transparent display device. The transparent display device may transmit light while displaying an image IM. Therefore, a user located in front of the transparent display device cannot only view the image IM displayed on the display device 10_5 but also view an object RS or the background located behind the transparent display device. When the display device 10_5 is applied to the transparent display device, a substrate of the display device 10_5 may include a light transmitting portion that can transmit light or may be made of a material that can transmit light.

In concluding the detailed description, those skilled in the art will appreciate that many variations and modifications can be made to the embodiments without substantially departing from the principles and scope of the present disclosure. Therefore, the embodiments of the present disclosure are used in a generic and descriptive sense only and not for purposes of limitation.

What is claimed is:

1. A display device comprising:
a first subpixel connected to a first data line and a first emission control line, and comprising a first light emitting element;
a second subpixel connected to a second data line and a second emission control line and comprising a second light emitting element;
a third subpixel connected to a third data line and a third emission control line and comprising a third light emitting element;
a data driver configured to output data voltages of the first subpixel, the second subpixel, and the third subpixel to the first data line, the second data line, and the third data line, respectively; and
a scan driver configured to output a first emission control signal of a first width, a second emission control signal of a second width, and a third emission control signal of a third width to the first emission control line, the second emission control line, and the third emission control line, respectively,
wherein the first subpixel, the second subpixel, and the third subpixel are configured to emit light during different times in response to the first emission control signal, the second emission control signal, and the third emission control signal, respectively.

2. The display device of claim 1,
wherein the data driver is configured to output the data voltages of different magnitudes to the first data line, the second data line, and the third data line, in response to each grey scale of video data.

3. The display device of claim 2,
wherein the first subpixel, the second subpixel, and the third subpixel comprise respective pixel circuits configured to generate a first driving current, a second driving current, and a third driving current, respectively, in response to the data voltages.

4. The display device of claim 3,
wherein the pixel circuit of the first subpixel is configured to supply the first driving current to the first light emitting element during a first emission period corresponding to the first width,
wherein the pixel circuit of the second subpixel is configured to supply the second driving current to the second light emitting element during a second emission period corresponding to the second width, and
wherein the pixel circuit of the third subpixel is configured to supply the third driving current to the third light emitting element during a third emission period corresponding to the third width.

5. The display device of claim 4,
wherein the first driving current is greater than the second driving current and the third driving current, and
wherein the first emission period is shorter than the second emission period and the third emission period.

6. The display device of claim 4,
wherein the second driving current is smaller than the first driving current and the third driving current, and
wherein the second emission period is longer than the first emission period and the third emission period.

7. The display device of claim 4,
wherein the first light emitting element, the second light emitting element, and the third light emitting element are configured to emit light of different colors and have different current efficiency.

8. The display device of claim 7,
wherein the first light emitting element is configured to emit first light of red color,
wherein the second light emitting element is configured to emit second light of green color, and
wherein the third light emitting element is configured to emit third light of blue color.

9. The display device of claim 8,
wherein the first driving current is greater than the second driving current and the third driving current, and
wherein the second driving current is smaller than the first driving current and the third driving current.

10. The display device of claim 9,
wherein the first emission period is shorter than the second emission period and the third emission period, and
wherein the second emission period is longer than the first emission period and the third emission period.

11. The display device of claim 8,
wherein the first light emitting element is configured to exhibit maximum efficiency at a current range of 100 μA to 300 μA, and
wherein the first driving current corresponding to a maximum gray level of the video data is in a range of 100 μA to 300 μA.

12. The display device of claim 8,
wherein the second light emitting element is configured to exhibit maximum efficiency at a current range of 10 μA to 20 μA, and
wherein the second driving current corresponding to a maximum gray level of the video data is in a range of 10 μA to 20 μA.

13. The display device of claim 8,
wherein the third light emitting element is configured to exhibit maximum efficiency at a current range of 20 μA to 40 μA, and
wherein the third driving current corresponding to a maximum gray level of the video data is in a range of 20 μA to 40 μA.

14. The display device of claim 4,
wherein the first driving current is N times the second driving current, and
wherein the first emission period is 1/N times the second emission period.

15. The display device of claim 1, further comprising a pixel comprising the first subpixel, the second subpixel, and the third subpixel,
wherein the first subpixel, the second subpixel, and the third subpixel are on a same horizontal line in a display area in which the pixel is located.

16. The display device of claim 15, further comprising at least one scan line connected to the first subpixel, the second subpixel, and the third subpixel.

17. The display device of claim 16,
wherein the scan driver comprises:
at least one scan signal output unit configured to output at least one scan signal to at least the one scan line; and
an emission control signal output unit configured to output the first emission control signal, the second emission control signal, and the third emission control signal to the first emission control line, the second emission control line, and the third emission control line, respectively.

18. A method of driving a display device, the method comprising:
driving a first subpixel, a second subpixel, and a third subpixel with driving currents of different magnitudes in response to each grey scale of video data; and
controlling emission periods of the first subpixel, the second subpixel, and the third subpixel to be different depending on the driving currents of the first subpixel, the second subpixel, and the third subpixel, respectively.

19. The method of claim 18,
wherein the driving the first subpixel, the second subpixel, and the third subpixel with the driving currents of different magnitudes comprises:
setting the driving currents of the first subpixel, the second subpixel, and the third subpixel as a first driving current, a second driving current, and a third driving current in accordance with efficiency of each of light emitting elements in the first subpixel, the second subpixel, and the third subpixel; and
supplying data voltages of magnitudes corresponding to the first driving current, the second driving current, and the third driving current to the first subpixel, the second subpixel, and the third subpixel, respectively.

20. The method of claim 19,
wherein the controlling the emission periods of the first subpixel, the second subpixel, and the third subpixel to be different comprises:
setting the emission periods of the first subpixel, the second subpixel, and the third subpixel to be different so that the emission periods decreases as magnitude of the driving current corresponding to each grey scale of video data increases; and
supplying the emission control signals corresponding to each of the emission periods of the first subpixel, the second subpixel, and the third subpixel to the first subpixel, the second subpixel, and the third subpixel.

21. An electronic device for providing an image, comprising:
a display device comprising:
a first subpixel connected to a first data line and a first emission control line, and comprising a first light emitting element;
a second subpixel connected to a second data line and a second emission control line and comprising a second light emitting element;
a third subpixel connected to a third data line and a third emission control line and comprising a third light emitting element;
a data driver configured to output data voltages of the first subpixel, the second subpixel, and the third subpixel to the first data line, the second data line, and the third data line, respectively; and
a scan driver configured to output a first emission control signal of a first width, a second emission control signal of a second width, and a third emission control signal of a third width to the first emission control line, the second emission control line, and the third emission control line, respectively,
wherein the first subpixel, the second subpixel, and the third subpixel are configured to emit light during different times in response to the first emission control signal, the second emission control signal, and the third emission control signal, respectively.
